(19) United States
(12) Patent Application Publication
(10) Pub. No.: US 2025/0159652 A1
(43) Pub. Date: May 15, 2025

(54) POSITIONING CAPABILITY REPORTING BASED ON MULTI-TRANSMISSION-RECEPTION POINTS

(71) Applicant: QUALCOMM Incorporated, San Diego, CA (US)

(72) Inventors: Mukesh KUMAR, Hyderabad (IN); Alexandros MANOLAKOS, Athens (GR); Srinivas YERRAMALLI, San Diego, CA (US)

(21) Appl. No.: 18/838,396

(22) PCT Filed: Mar. 8, 2023
(86) PCT No.: PCT/US2023/063925

§ 371 Date: Aug. 14, 2024

(30) Foreign Application Priority Data
Mar. 28, 2022 (GR) 20220100268

(51) Int. Cl. H04W 64/00; H04L 5/00

(52) U.S. Cl. CPC H04W 64/003; H04L 5/0044

(57) ABSTRACT

In an aspect, a user equipment (UE) may operate in a multi-transmission-reception (multi-TRP) mode. The UE may engage in a positioning session with a network entity while operating in the multi-TRP mode. The UE may report a set of positioning capabilities for the positioning session to the network entity, wherein the set of positioning capabilities indicate one or more enhanced positioning capabilities of the UE to perform positioning operations based on the UE operating in the multi-TRP mode, and wherein the one or more enhanced positioning capabilities are greater than one or more corresponding positioning capabilities of the UE to perform positioning operations based on the UE operating in a single-transmission-reception (S-TRP) mode.

### CROSS-REFERENCE TO RELATED APPLICATIONS

The present Application for Patent claims the benefit of GR application Ser. No. 20220100268, entitled “POSITIONING CAPABILITY REPORTING BASED ON MULTI-TRANSMISSION-RECEPTION POINTS”, filed Mar. 28, 2022, and is a national stage application, filed under 35 U.S.C. § 371, of International Patent Application No. PCT/US2023/063925, entitled, “POSITIONING CAPABILITY REPORTING BASED ON MULTI-TRANSMISSION-RECEPTION POINTS”, filed Mar. 8, 2023, both of which are assigned to the assignee hereof and are expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher its data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a user equipment (UE) includes operating in a multi-transmission-reception point (multi-TRP) mode: engaging in a positioning session with a network entity while operating in the multi-TRP mode; and reporting a set of positioning capabilities for the positioning session to the network entity, wherein the set of positioning capabilities indicate one or more enhanced positioning capabilities of the UE to perform positioning operations based on the UE operating in the multi-TRP mode, and wherein the one or more enhanced positioning capabilities are greater than one or more corresponding positioning capabilities of the UE to perform positioning operations based on the UE operating in a single-transmission-reception point (S-TRP) mode.

In an aspect, a method of wireless communication performed by a user equipment (UE) includes engaging in a positioning session with a network entity while operating in a multi-transmission-reception point (multi-TRP) mode; receiving a measurement request to measure a plurality of positioning reference signal (PRS) resources for the positioning session; and measuring an enhanced set of the plurality of PRS resources during a measurement period based on the UE being in the multi-TRP mode, wherein the enhanced set of the plurality of PRS resources includes more PRS resources than a nominal set of the plurality of PRS resources that the UE is capable of measuring during the measurement period, measurement occasion, or measurement instance while operating in a single-transmission-reception point (S-TRP) mode.

In an aspect, a user equipment (UE) includes a memory; at least one transceiver; and at least one processor communicatively coupled to the memory and the at least one transceiver, the at least one processor configured to: operate in a multi-transmission-reception point (multi-TRP) mode; engage in a positioning session with a network entity while operating in the multi-TRP mode; and report, via the at least one transceiver, a set of positioning capabilities for the positioning session to the network entity, wherein the set of positioning capabilities indicate one or more enhanced positioning capabilities of the UE to perform positioning operations based on the UE operating in the multi-TRP mode, and wherein the one or more enhanced positioning capabilities are greater than one or more corresponding positioning capabilities of the UE to perform positioning operations based on the UE operating in a single-transmission-reception point (S-TRP) mode.

In an aspect, a user equipment (UE) includes a memory; at least one transceiver; and at least one processor communicatively coupled to the memory and the at least one transceiver, the at least one processor configured to: engage in a positioning session with a network entity while operating in a multi-transmission-reception point (multi-TRP) mode; receive, via the at least one transceiver, a measurement request to measure a plurality of positioning reference signal (PRS) resources for the positioning session; and measure an enhanced set of the plurality of PRS resources during a measurement period based on the UE being in the multi-TRP mode, wherein the enhanced set of the plurality of PRS resources includes more PRS resources than a nominal set of the plurality of PRS resources that the UE is capable of measuring during the measurement period, measurement occasion, or measurement instance while operating in a single-transmission-reception point (S-TRP) mode.

In an aspect, a user equipment (UE) includes means for operating in a multi-transmission-reception point (multi-TRP) mode; means for engaging in a positioning session with a network entity while operating in the multi-TRP mode; and means for reporting a set of positioning capabilities for the positioning session to the network entity, wherein the set of positioning capabilities indicate one or more enhanced positioning capabilities of the UE to perform positioning operations based on the UE operating in the multi-TRP mode, and wherein the one or more enhanced positioning capabilities are greater than one or more corresponding positioning capabilities of the UE to perform positioning operations based on the UE operating in a single-transmission-reception point (S-TRP) mode.

In an aspect, a user equipment (UE) includes means for engaging in a positioning session with a network entity while operating in a multi-transmission-reception point (multi-TRP) mode: means for receiving a measurement request to measure a plurality of positioning reference signal (PRS) resources for the positioning session; and means for measuring an enhanced set of the plurality of PRS resources during a measurement period based on the UE being in the multi-TRP mode, wherein the enhanced set of the plurality of PRS resources includes more PRS resources than a nominal set of the plurality of PRS resources that the UE is capable of measuring during the measurement period, measurement occasion, or measurement instance while operating in a single-transmission-reception point (S-TRP) mode.

In an aspect, a non-transitory computer-readable medium stores computer-executable instructions that, when executed by a user equipment (UE), cause the UE to: operate in a multi-transmission-reception point (multi-TRP) mode: engage in a positioning session with a network entity while operating in the multi-TRP mode; and report a set of positioning capabilities for the positioning session to the network entity, wherein the set of positioning capabilities indicate one or more enhanced positioning capabilities of the UE to perform positioning operations based on the UE operating in the multi-TRP mode, and wherein the one or more enhanced positioning capabilities are greater than one or more corresponding positioning capabilities of the UE to perform positioning operations based on the UE operating in a single-transmission-reception point (S-TRP) mode.

In an aspect, a non-transitory computer-readable medium stores computer-executable instructions that, when executed by an UE, cause the UE to: engage in a positioning session with a network entity while operating in a multi-transmission-reception point (multi-TRP) mode; receive a measurement request to measure a plurality of positioning reference signal (PRS) resources for the positioning session; and measure an enhanced set of the plurality of PRS resources during a measurement period based on the UE being in the multi-TRP mode, wherein the enhanced set of the plurality of PRS resources includes more PRS resources than a nominal set of the plurality of PRS resources that the UE is capable of measuring during the measurement period, measurement occasion, or measurement instance while operating in a single-transmission-reception point (S-TRP) mode.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example frame structure, according to aspects of the disclosure.

FIG. 5 is a diagram illustrating various downlink channels within an example downlink slot, according to aspects of the disclosure.

FIG. 6 illustrates an example Long-Term Evolution (LTE) positioning protocol (LPP) call flow between a UE and a location server for performing positioning operations.

FIG. 7 is a diagram illustrating an example downlink positioning reference signal (DL-PRS) configuration for two transmission-reception points (TRPs) operating in the same positioning frequency layer, according to aspects of the disclosure.

FIG. 8 illustrates an example antenna for illustrating transmission (Tx) and reception (Rx) timing error groups (TEGs), according to aspects of the disclosure.

FIGS. 9A and 9B illustrate different Rx TEG processing capabilities of a UE, according to aspects of the disclosure.

FIG. 10A shows a single-transmission-reception point (S-TRP) mode configuration in which the UE is in communication with a single TRP, according to aspects of the disclosure.

FIG. 10B shows several multi-transmission-reception point (multi-TRP) mode configurations of the UE, according to aspects of the disclosure.

FIGS. 11A and 11B show an example set of information elements (IEs) that may be used to indicate the positioning reference signal (PRS) processing capabilities of the UE to a network entity, according to aspects of the disclosure.

FIGS. 12A and 12B show an example set of IEs that may be used to indicate the PRS processing capabilities of the UE to a network entity, according to aspects of the disclosure.

FIG. 13 illustrates an example method of wireless communication performed by a user equipment (UE), according to aspects of the disclosure.

FIG. 14 illustrates an example method of wireless communication performed by a user equipment (UE), according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-cNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

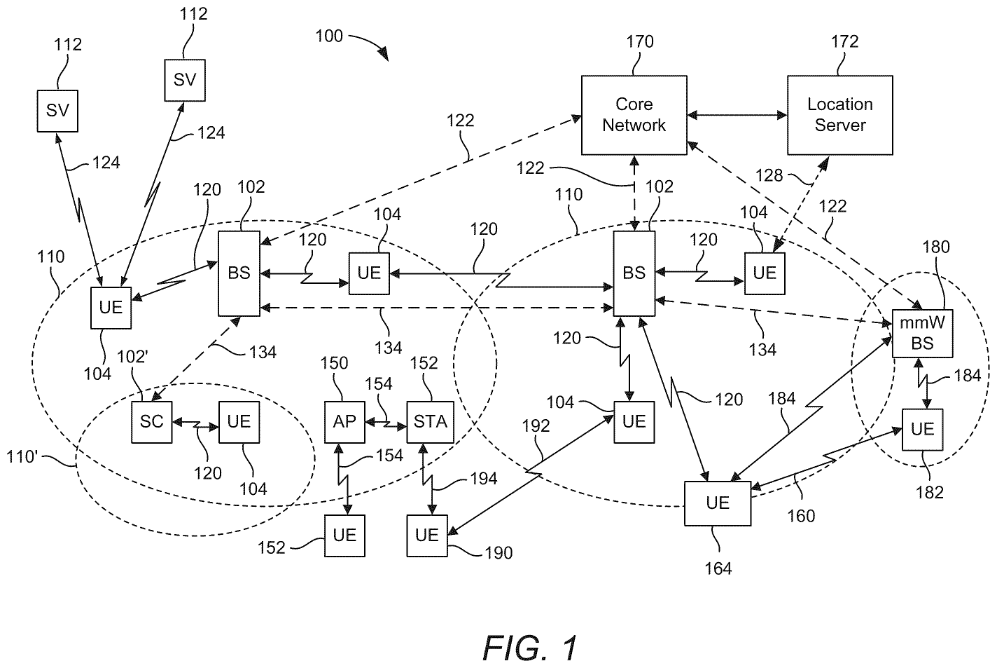

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages. NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

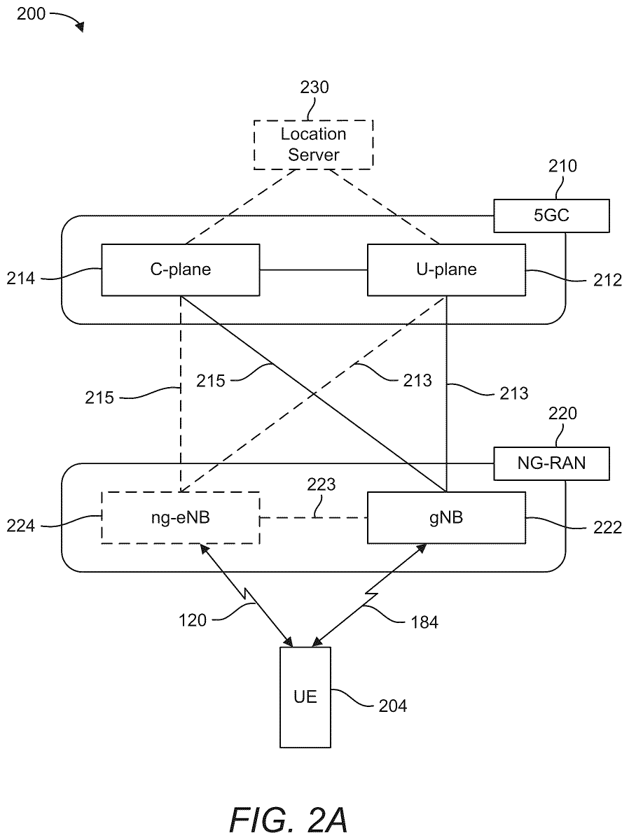

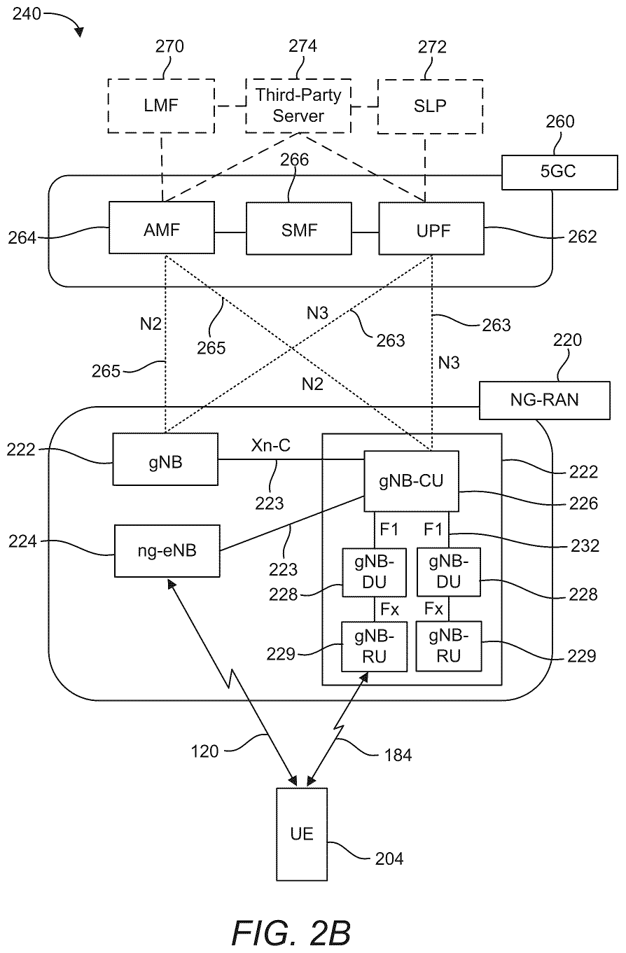

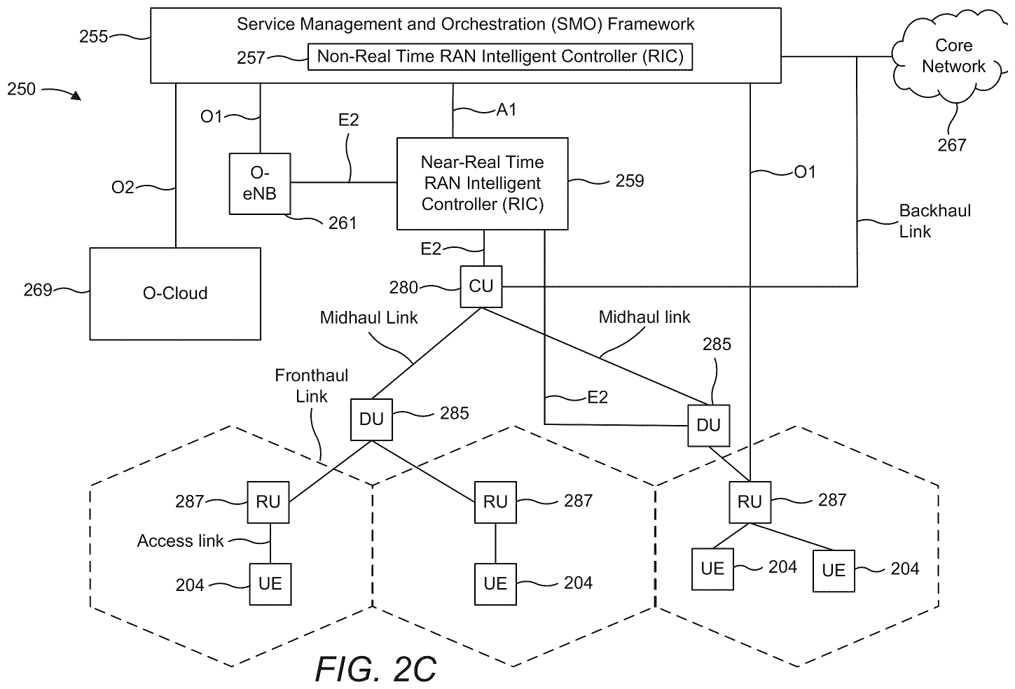

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-cNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, access point (AP), a transmit receive point (TRP), or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C is a diagram 250 illustrating an example disaggregated base station architecture, according to aspects of the disclosure. The disaggregated base station 250 architecture may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more distributed units (DUs) 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUs 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 280 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

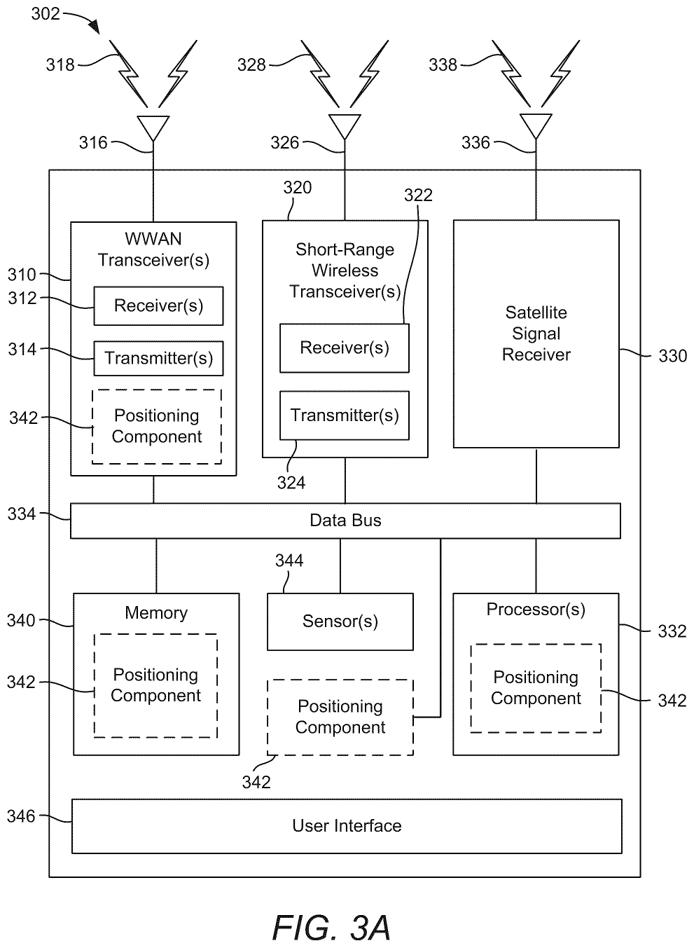

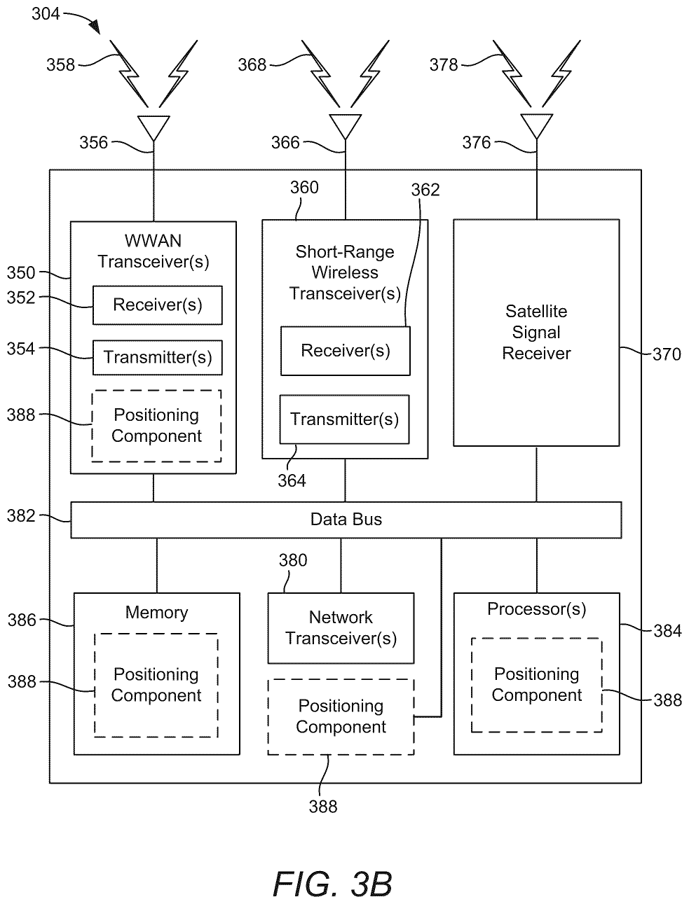

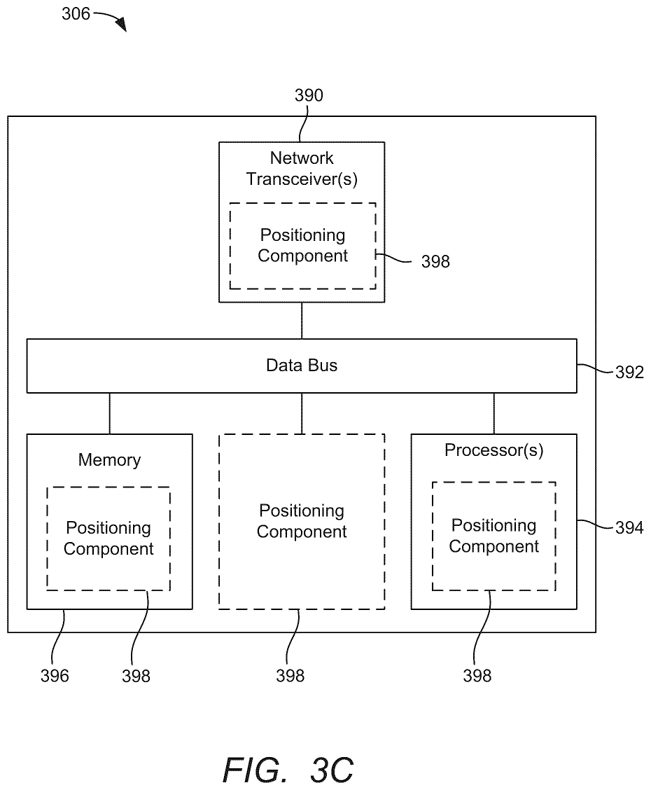

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR. LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals. Galileo signals. Beidou signals, Indian Regional Navigation Satellite System (NAVIC). Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink. IP packets from the network entity 306 may be provided to the processor 384. The one or more processors 384 may implement functionality for an RRC layer, a packet data convergence protocol (PDCP) layer, a radio link control (RLC) layer, and a medium access control (MAC) laver. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting: PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK). M-phase-shift keying (M-PSK). M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE.” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

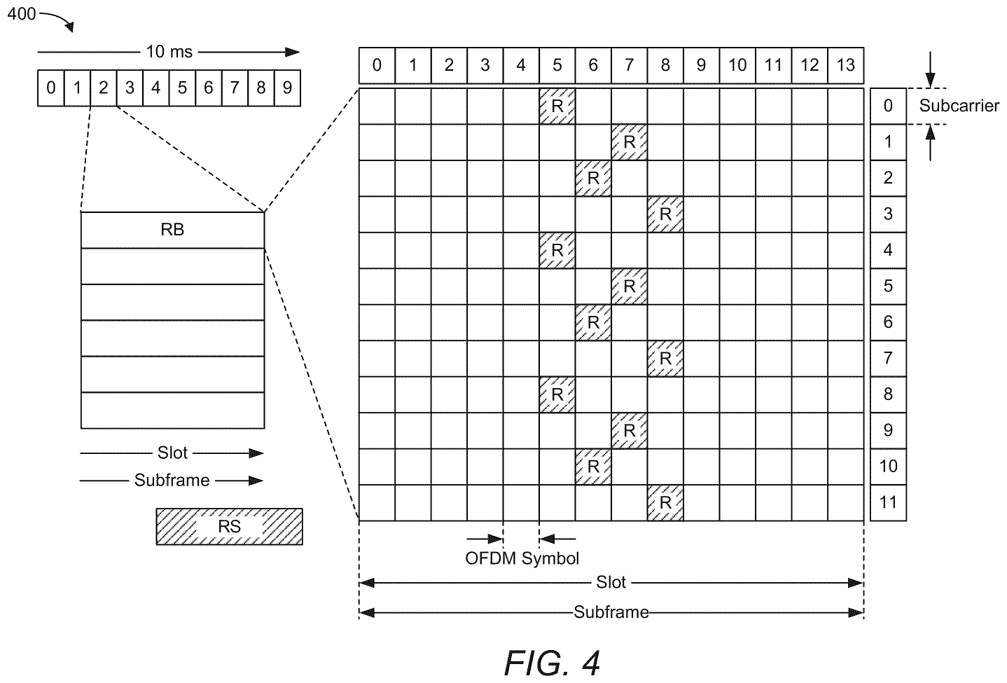

Various frame structures may be used to support downlink and uplink transmissions between network nodes (e.g., base stations and UEs). FIG. 4 is a diagram 400 illustrating an example frame structure, according to aspects of the disclosure. The frame structure may be a downlink or uplink frame structure. Other wireless communications technologies may have different frame structures and/or different channels.

LTE, and in some cases NR, utilizes orthogonal frequency-division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast. NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe. 20 slots per frame, the slot duration is 0.5 ms, the symbol duration is 33.3 μs, and the maximum nominal system bandwidth (in MHz) with a 4K FFT size is 100. For 60 KHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4, a numerology of 15 kHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

A collection of resource elements (REs) that are used for transmission of PRS is referred to as a “PRS resource.” The collection of resource elements can span multiple PRBs in the frequency domain and ‘N’ (such as 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size ‘N’ represents the subcarrier spacing (or frequency/tone spacing) within each symbol of a PRS resource configuration. Specifically, for a comb size ‘N,’ PRS are transmitted in every Nth subcarrier of a symbol of a PRB. For example, for comb-4, for each symbol of the PRS resource configuration, REs corresponding to every fourth subcarrier (such as subcarriers 0, 4, 8) are used to transmit PRS of the PRS resource. Currently, comb sizes of comb-2, comb-4, comb-6, and comb-12 are supported for DL-PRS. FIG. 4 illustrates an example PRS resource configuration for comb-4 (which spans four symbols). That is, the locations of the shaded REs (labeled “R”) indicate a comb-4 PRS resource configuration.

Currently, a DL-PRS resource may span 2, 4, 6, or 12 consecutive symbols within a slot with a fully frequency-domain staggered pattern. A DL-PRS resource can be configured in any higher layer configured downlink or flexible (FL) symbol of a slot. There may be a constant energy per resource element (EPRE) for all REs of a given DL-PRS resource. The following are the frequency offsets from symbol to symbol for comb sizes 2, 4, 6, and 12 over 2, 4, 6, and 12 symbols. 2-symbol comb-2: {0, 1}: 4-symbol comb-2: {0, 1, 0, 1}: 6-symbol comb-2: {0, 1, 0, 1, 0, 1}: 12-symbol comb-2: {0, 1, 0, 1, 0, 1, 0, 1, 0, 1, 0, 1}: 4-symbol comb-4: {0, 2, 1, 3} (as in the example of FIG. 4): 12-symbol comb-4: {0, 2, 1, 3, 0, 2, 1, 3, 0, 2, 1, 3}: 6-symbol comb-6: {0, 3, 1, 4, 2, 5}: 12-symbol comb-6: {0, 3, 1, 4, 2, 5, 0, 3, 1, 4, 2, 5}; and 12-symbol comb-12: {0, 6, 3, 9, 1, 7, 4, 10, 2, 8, 5, 11}.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2\hat{ }μ*{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion,” a “PRS positioning instance, a “positioning occasion,” “a positioning instance,” a “positioning repetition,” or simply an “occasion,” an “instance,” or a “repetition.”

A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the physical downlink shared channel (PDSCH) are also supported for PRS), the same Point A, the same value of the downlink PRS bandwidth, the same start PRB (and center frequency), and the same comb-size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink, uplink, or sidelink positioning reference signals, unless otherwise indicated by the context. If needed to further distinguish the type of PRS, a downlink positioning reference signal may be referred to as a “DL-PRS,” an uplink positioning reference signal (e.g., an SRS-for-positioning, PTRS) may be referred to as an “UL-PRS,” and a sidelink positioning reference signal may be referred to as an “SL-PRS.” In addition, for signals that may be transmitted in the downlink, uplink, and/or sidelink (e.g., DMRS), the signals may be prepended with “DL,” “UL,” or “SL” to distinguish the direction. For example, “UL-DMRS” is different from “DL-DMRS.”

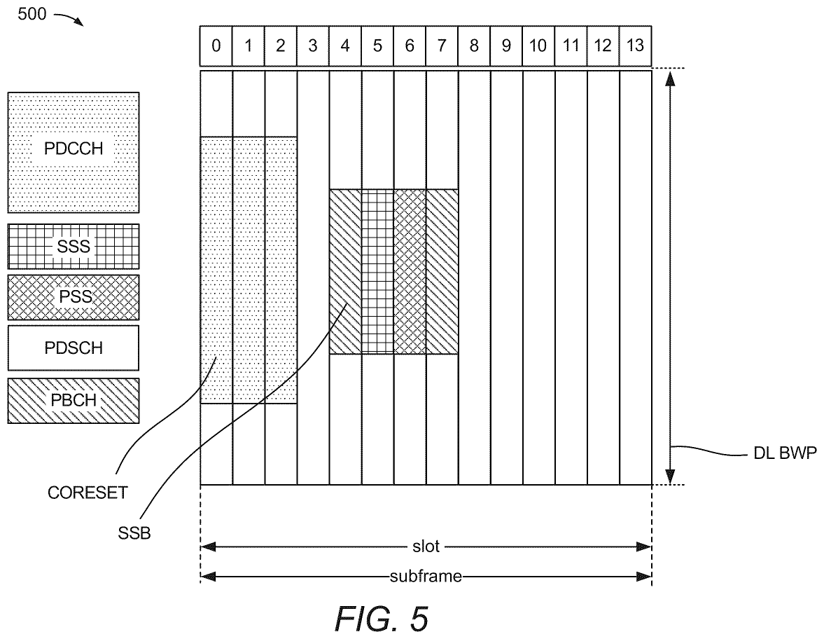

FIG. 5 is a diagram 500 illustrating various downlink channels within an example downlink slot. In FIG. 5, time is represented horizontally (on the X axis) with time increasing from left to right, while frequency is represented vertically (on the Y axis) with frequency increasing (or decreasing) from bottom to top. In the example of FIG. 5, a numerology of 15 kHz is used. Thus, in the time domain, the illustrated slot is one millisecond (ms) in length, divided into 14 symbols.

In NR, the channel bandwidth, or system bandwidth, is divided into multiple bandwidth parts (BWPs). A BWP is a contiguous set of RBs selected from a contiguous subset of the common RBs for a given numerology on a given carrier. Generally, a maximum of four BWPs can be specified in the downlink and uplink. That is, a UE can be configured with up to four BWPs on the downlink, and up to four BWPs on the uplink. Only one BWP (uplink or downlink) may be active at a given time, meaning the UE may only receive or transmit over one BWP at a time. On the downlink, the bandwidth of each BWP should be equal to or greater than the bandwidth of the SSB, but it may or may not contain the SSB.

Referring to FIG. 5, a primary synchronization signal (PSS) is used by a UE to determine subframe/symbol timing and a physical layer identity. A secondary synchronization signal (SSS) is used by a UE to determine a physical layer cell identity group number and radio frame timing. Based on the physical layer identity and the physical layer cell identity group number, the UE can determine a PCI. Based on the PCI, the UE can determine the locations of the aforementioned DL-RS. The physical broadcast channel (PBCH), which carries a master information block (MIB), may be logically grouped with the PSS and SSS to form an SSB (also referred to as an SS/PBCH). The MIB provides a number of RBs in the downlink system bandwidth and a system frame number (SFN). The physical downlink shared channel (PDSCH) carries user data, broadcast system information not transmitted through the PBCH, such as system information blocks (SIBs), and paging messages.

The physical downlink control channel (PDCCH) carries downlink control information (DCI) within one or more control channel elements (CCEs), each CCE including one or more RE group (REG) bundles (which may span multiple symbols in the time domain), each REG bundle including one or more REGs, each REG corresponding to 12 resource elements (one resource block) in the frequency domain and one OFDM symbol in the time domain. The set of physical resources used to carry the PDCCH/DCI is referred to in NR as the control resource set (CORESET). In NR, a PDCCH is confined to a single CORESET and is transmitted with its own DMRS. This enables UE-specific beamforming for the PDCCH.

In the example of FIG. 5, there is one CORESET per BWP, and the CORESET spans three symbols (although it may be only one or two symbols) in the time domain. Unlike LTE control channels, which occupy the entire system bandwidth, in NR, PDCCH channels are localized to a specific region in the frequency domain (i.e., a CORESET). Thus, the frequency component of the PDCCH shown in FIG. 5 is illustrated as less than a single BWP in the frequency domain. Note that although the illustrated CORESET is contiguous in the frequency domain, it need not be. In addition, the CORESET may span less than three symbols in the time domain.

The DCI within the PDCCH carries information about uplink resource allocation (persistent and non-persistent) and descriptions about downlink data transmitted to the UE, referred to as uplink and downlink grants, respectively. More specifically, the DCI indicates the resources scheduled for the downlink data channel (e.g., PDSCH) and the uplink data channel (e.g., physical uplink shared channel (PUSCH)). Multiple (e.g., up to eight) DCIs can be configured in the PDCCH, and these DCIs can have one of multiple formats. For example, there are different DCI formats for uplink scheduling, for downlink scheduling, for uplink transmit power control (TPC), etc. A PDCCH may be transported by 1, 2, 4, 8, or 16 CCEs in order to accommodate different DCI payload sizes or coding rates.

As will be appreciated, a UE needs to be able to demodulate (also referred to as “decode”) the PDCCH in order to read the DCI, and thereby to obtain the scheduling of resources allocated to the UE on the PDSCH and PUSCH. If the UE fails to demodulate the PDCCH, then the UE will not know the locations of the PDSCH resources and it will keep attempting to demodulate the PDCCH using a different set of PDCCH candidates in subsequent PDCCH monitoring occasions. If the UE fails to demodulate the PDCCH after some number of attempts, the UE declares a radio link failure (RLF). To overcome PDCCH demodulation issues, search spaces are configured for efficient PDCCH detection and demodulation.

Generally, a UE does not attempt to demodulate each and every PDCCH candidate that may be scheduled in a slot. To reduce restrictions on the PDCCH scheduler, and at the same time to reduce the number of blind demodulation attempts by the UE, search spaces are configured. Search spaces are indicated by a set of contiguous CCEs that the UE is expected to monitor for scheduling assignments/grants relating to a certain component carrier. There are two types of search spaces used for the PDCCH to control each component carrier, a common search space (CSS) and a UE-specific search space (USS).

A common search space is shared across all UEs, and a UE-specific search space is used per UE (i.e., a UE-specific search space is specific to a specific UE). For a common search space, a DCI cyclic redundancy check (CRC) is scrambled with a system information radio network temporary identifier (SI-RNTI), random access RNTI (RA-RNTI), temporary cell RNTI (TC-RNTI), paging RNTI (P-RNTI), interruption RNTI (INT-RNTI), slot format indication RNTI (SFI-RNTI), TPC-PUCCH-RNTI, TPC-PUSCH-RNTI, TPC-SRS-RNTI, cell RNTI (C-RNTI), or configured scheduling RNTI (CS-RNTI) for all common procedures. For a UE-specific search space, a DCI CRC is scrambled with a C-RNTI or CS-RNTI, as these are specifically targeted to individual UE.

A UE demodulates the PDCCH using the four UE-specific search space aggregation levels (1, 2, 4, and 8) and the two common search space aggregation levels (4 and 8). Specifically, for the UE-specific search spaces, aggregation level ‘l’ has six PDCCH candidates per slot and a size of six CCEs. Aggregation level ‘2’ has six PDCCH candidates per slot and a size of 12 CCEs. Aggregation level ‘4’ has two PDCCH candidates per slot and a size of eight CCEs. Aggregation level ‘8’ has two PDCCH candidates per slot and a size of 16 CCEs. For the common search spaces, aggregation level ‘4’ has four PDCCH candidates per slot and a size of 16 CCEs. Aggregation level ‘8’ has two PDCCH candidates per slot and a size of 16 CCEs.

Each search space comprises a group of consecutive CCEs that could be allocated to a PDCCH, referred to as a PDCCH candidate. A UE demodulates all of the PDCCH candidates in these two search spaces (USS and CSS) to discover the DCI for that UE. For example, the UE may demodulate the DCI to obtain the scheduled uplink grant information on the PUSCH and the downlink resources on the PDSCH. Note that the aggregation level is the number of REs of a CORESET that carry a PDCCH DCI message, and is expressed in terms of CCEs. There is a one-to-one mapping between the aggregation level and the number of CCEs per aggregation level. That is, for aggregation level ‘4,’ there are four CCEs. Thus, as shown above, if the aggregation level is ‘4’ and the number of PDCCH candidates in a slot is ‘2,’ then the size of the search space is ‘8’ (i.e., 4×2=8).

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. In an OTDOA or DL-TDOA positioning procedure, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 HS.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

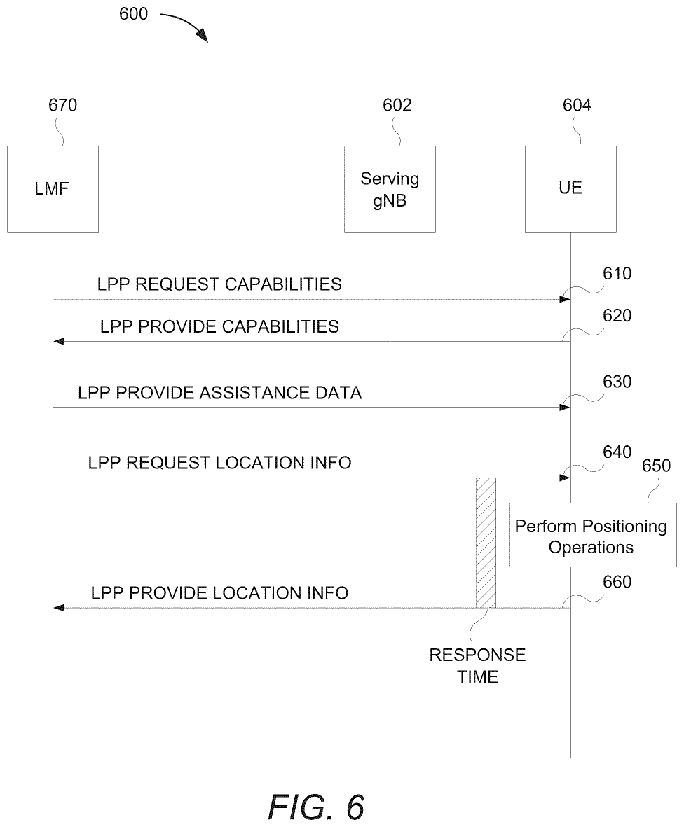

FIG. 6 illustrates an example Long-Term Evolution (LTE) positioning protocol (LPP) procedure 600 between a UE 604 and a location server (illustrated as a location management function (LMF) 670) for performing positioning operations. As illustrated in FIG. 6, the positioning of the UE 604 is supported via an exchange of LPP messages between the UE 604 and the LMF 670. The LPP messages may be exchanged between UE 604 and the LMF 670 via the UE's 604 serving base station (illustrated as a serving gNB 602) and a core network (not shown). The LPP procedure 600 may be used to position the UE 604 in order to support various location-related services, such as navigation for UE 604 (or for the user of UE 604), or for routing, or for provision of an accurate location to a public safety answering point (PSAP) in association with an emergency call from UE 604 to a PSAP, or for some other reason. The LPP procedure 600 may also be referred to as a positioning session, and there may be multiple positioning sessions for different types of positioning methods (e.g., downlink time difference of arrival (DL-TDOA), round-trip-time (RTT), enhanced cell identity (E-CID), etc.).

Initially, the UE 604 may receive a request for its positioning capabilities from the LMF 670 at stage 610 (e.g., an LPP Request Capabilities message). At stage 620, the UE 604 provides its positioning capabilities to the LMF 670 relative to the LPP protocol by sending an LPP Provide Capabilities message to LMF 670 indicating the positioning methods and features of these positioning methods that are supported by the UE 604 using LPP. The capabilities indicated in the LPP Provide Capabilities message may, in some aspects, indicate the type of positioning the UE 604 supports (e.g., DL-TDOA, RTT, E-CID, etc.) and may indicate the capabilities of the UE 604 to support those types of positioning.

Upon reception of the LPP Provide Capabilities message, at stage 620, the LMF 670 determines to use a particular type of positioning method (e.g., DL-TDOA, RTT, E-CID, etc.) based on the indicated type(s) of positioning the UE 604 supports and determines a set of one or more transmission-reception points (TRPs) from which the UE 604 is to measure downlink positioning reference signals or towards which the UE 604 is to transmit uplink positioning reference signals. At stage 630, the LMF 670 sends an LPP Provide Assistance Data message to the UE 604 identifying the set of TRPs.

In some implementations, the LPP Provide Assistance Data message at stage 630 may be sent by the LMF 670 to the UE 604 in response to an LPP Request Assistance Data message sent by the UE 604 to the LMF 670 (not shown in FIG. 6). An LPP Request Assistance Data message may include an identifier of the UE's 604 serving TRP and a request for the positioning reference signal (PRS) configuration of neighboring TRPs.

At stage 640, the LMF 670 sends a request for location information to the UE 604. The request may be an LPP Request Location Information message. This message usually includes information elements (IEs) defining the location information type, desired accuracy of the location estimate, and response time (i.e., desired latency). Note that a low latency requirement allows for a longer response time, while a high latency requirement requires a shorter response time. However, a long response time is referred to as high latency, and a short response time is referred to as low latency.

Note that in some implementations, the LPP Provide Assistance Data message sent at stage 630 may be sent after the LPP Request Location Information message at 640 if, for example, the UE 604 sends a request for assistance data to LMF 670 (e.g., in an LPP Request Assistance Data message, not shown in FIG. 6) after receiving the request for location information at stage 640.

At stage 650, the UE 604 utilizes the assistance information received at stage 630 and any additional data (e.g., a desired location accuracy or a maximum response time) received at stage 640 to perform positioning operations (e.g., measurements of DL-PRS, transmission of UL-PRS, etc.) for the selected positioning method.

At stage 660, the UE 604 may send an LPP Provide Location Information message to the LMF 670 conveying the results of any measurements that were obtained at stage 650 (e.g., time of arrival (ToA), reference signal time difference (RSTD), reception-to-transmission (Rx-Tx), etc.) and before or when any maximum response time has expired (e.g., a maximum response time provided by the LMF 670 at stage 640). The LPP Provide Location Information message at stage 660 may also include the time (or times) at which the positioning measurements were obtained and the identity of the TRP(s) from which the positioning measurements were obtained. Note that the time between the request for location information at 640 and the response at 660 is the “response time” and indicates the latency of the positioning session.

The LMF 670 computes an estimated location of the UE 604 using the appropriate positioning techniques (e.g., DL-TDOA, RTT, E-CID, etc.) based, at least in part, on measurements received in the LPP Provide Location Information message at stage 660.

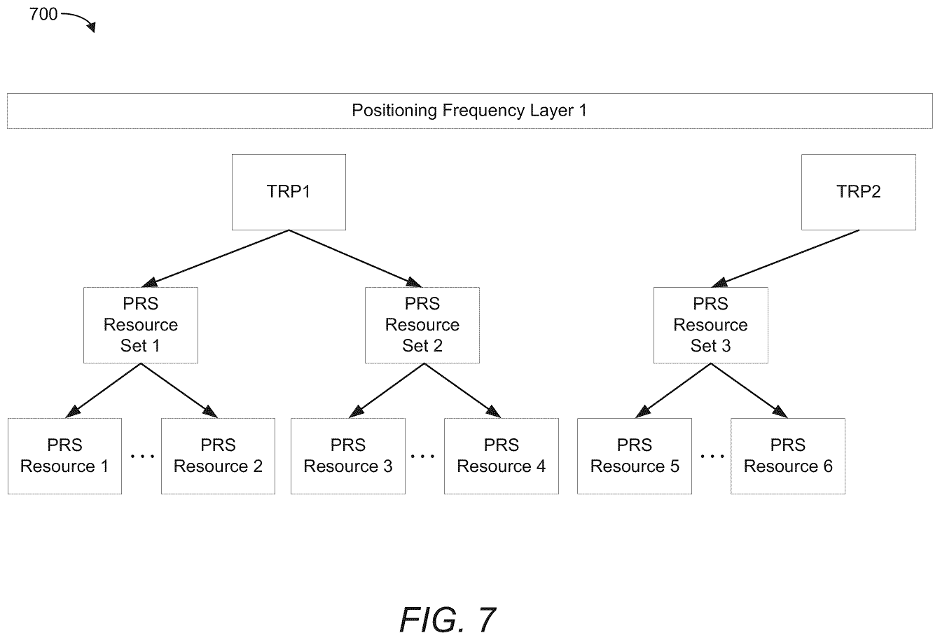

FIG. 7 is a diagram 700 illustrating an example PRS configuration for two TRPs (labeled “TRP1” and “TRP2”) operating in the same positioning frequency layer (labeled “Positioning Frequency Layer 1”), according to aspects of the disclosure. For a positioning session, a UE may be provided with assistance data indicating the illustrated PRS configuration. In the example of FIG. 7, the first TRP (“TRP1”) is associated with (e.g., transmits) two PRS resource sets, labeled “PRS Resource Set 1” and “PRS Resource Set 2,” and the second TRP (“TRP2”) is associated with one PRS resource set, labeled “PRS Resource Set 3.” Each PRS resource set comprises at least two PRS resources. Specifically, the first PRS resource set (“PRS Resource Set 1”) includes PRS resources labeled “PRS Resource 1” and “PRS Resource 2,” the second PRS resource set (“PRS Resource Set 2”) includes PRS resources labeled “PRS Resource 3” and “PRS Resource 4,” and the third PRS resource set (“PRS Resource Set 3”) includes PRS resources labeled “PRS Resource 5” and “PRS Resource 6.”

A UE reports its capability to process PRS in the capability update (e.g., an LPP Provide Capabilities message as at stage 620). The assistance data received based on the UE's capability information (e.g., in the LPP Provide Assistance Data message at stage 630) includes the information needed to perform measurements of PRS for the positioning session (e.g., the configurations of the PRS resources to measure from one or more base stations/TRPs/cells). However, the assistance data may identify significantly more PRS resources to measure than the UE is capable of processing. For example, a UE may be able to process only up to five PRS resources, whereas the PRS assistance data may identify 20 PRS resources to measure.

Currently, in such cases, the UE selects the first five PRS resources for processing. Specifically, it has been agreed that when a UE is configured in the assistance data of a positioning method with a number of PRS resources beyond its capability, the UE assumes the PRS resources in the assistance data are sorted in a decreasing order of measurement priority. According to the current structure of the assistance data, the following priority is assumed: the 64 TRPs per frequency layer are sorted according to priority, and the two PRS resource sets per TRP of the frequency layer are sorted according to priority. The four frequency layers may or may not be sorted according to priority, and the 64 PRS resources of the PRS resource set per TRP per frequency layer may or may not be sorted according to priority. Note that the reference PRS resource indicated by the “nr-DL-PRS-ReferenceInfo-r16” LPP IE for each frequency layer has the highest priority, at least for DL-TDOA.

A UE is expected to report one or more measurement instances (of RSTD, downlink RSRP, and/or UE Rx-Tx time difference measurements) in a single measurement report (e.g., in the LPP Provide Location Information message at stage 660) to the location server for UE-assisted positioning (there is no such reporting for UE-based positioning). Each UE measurement instance can be configured with ‘N’ (including N=1) instances of a DL-PRS resource set. Similarly, a TRP is expected to report one or more measurement instances (of relative ToA (RTOA), uplink RSRP, and/or base station Rx-Tx time difference measurements) in a single measurement report to the location server (e.g., via NR positioning protocol type A (NRPPa)). Each measurement instance is reported with its own timestamp, and the measurement instances may be within a (configured) measurement window. Each TRP measurement instance can be configured with ‘M’ (including M=1) SRS measurement time occasions. Note that a measurement instance refers to one or more measurements, which can either be the same or different types, and which are obtained from the same DL-PRS resource(s) or the same SRS resource(s).

Each measurement instance is also reported with its own timing error to enable the positioning entity to compensate for the timing error or to determine an uncertainty based on the timing error. The following definitions are used for the purpose of describing internal timing errors:

Transmit (Tx) timing error: From a signal transmission perspective, there is a time delay from the time when the digital signal is generated at the baseband to the time when the RF signal is transmitted from the transmit antenna. For supporting positioning, the UE/TRP may implement an internal calibration/compensation of the transmit time delay for the transmission of the DL-PRS/UL-SRS, which may also include the calibration/compensation of the relative time delay between different RF chains in the same UE/TRP. The compensation may also consider the offset of the transmit antenna phase center to the physical antenna center. However, the calibration may not be perfect. The remaining transmit time delay after the calibration, or the uncalibrated transmit time delay is defined as the “transmit timing error” or “Tx timing error.”

Receive (Rx) timing error: From a signal reception perspective, there is a time delay from the time when the RF signal arrives at the Rx antenna to the time when the signal is digitized and time-stamped at the baseband. For supporting positioning, the UE/TRP may implement an internal calibration/compensation of the Rx time delay before it reports the measurements that are obtained from the DL-PRS/SRS, which may also include the calibration/compensation of the relative time delay between different RF chains in the same UE/TRP. The compensation may also consider the offset of the Rx antenna phase center to the physical antenna center. However, the calibration may not be perfect. The remaining Rx time delay after the calibration, or the uncalibrated Rx time delay, is defined as the “Rx timing error.”

UE Tx timing error group (TEG): A UE Tx TEG (or TxTEG) is associated with the transmissions of one or more SRS resources for the positioning purpose, which have the Tx timing errors within a certain margin (e.g., within a threshold of each other).

TRP Tx TEG: A TRP Tx TEG (or TxTEG) is associated with the transmissions of one or more DL-PRS resources, which have the Tx timing errors within a certain margin.

UE Rx TEG: A UE Rx TEG (or RxTEG) is associated with one or more downlink measurements, which have the Rx timing errors within a certain margin.

TRP Rx TEG: A TRP Rx TEG (or RxTEG) is associated with one or more uplink measurements, which have the Rx timing errors within a margin.

UE Rx-Tx TEG: A UE Rx-Tx TEG (or RxTxTEG) is associated with one or more UE Rx-Tx time difference measurements, and one or more SRS resources for the positioning purpose, which have the Rx timing errors plus Tx timing errors within a certain margin.

TRP Rx-Tx TEG: A TRP Rx-Tx TEG (or RxTxTEG) is associated with one or more TRP Rx-Tx time difference measurements and one or more DL-PRS resources, which have the Rx timing errors plus Tx timing errors within a certain margin.

For mitigating UE Tx/Rx timing errors for downlink-and-uplink-based positioning methods, it has been agreed that a UE may support, up to the UE's capability, one or both of the following options: (1) reporting of UE RxTxTEG ID is supported by the UE or (2) reporting of UE RxTxTEG ID is not supported by the UE but reporting of Rx TEG ID and Tx TEG ID is supported. In either option, a Tx TEG ID is associated with an SRS resource for positioning corresponding to the transmit timing of the UE's Rx-Tx time difference measurement, the transmit timing of the UE's Rx-Tx time difference measurement, or one or more SRS resources for positioning. An Rx TEG ID is associated with one or more DL-PRS resources corresponding to the receive time of the measurement.

For mitigating UE transmit timing errors for UL-TDOA, it has been agreed that one of the following options should be supported: (1) subject to the UE's capability, support a UE providing the association information of SRS resources for positioning with Tx TEGs directly to the location server if the UE has multiple Tx TEGs, or, (2) subject to the UE's capability, support a UE providing the association information of SRS resources for positioning with Tx TEGs to the serving base station if the UE has multiple Tx TEGs. In the second option, the serving base station would forward the association information provided by the UE to the location server. The involved base station(s) should also report the associated SRS resource ID and SRS resource set ID of the RTOA measurement to the location server.

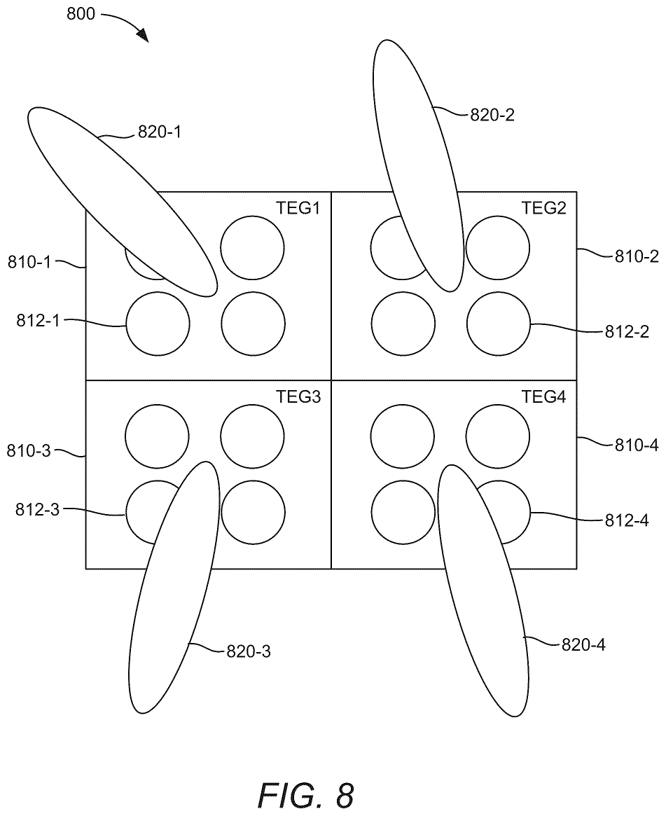

FIG. 8 illustrates an example antenna 800 for illustrating Tx and Rx TEGs, according to aspects of the disclosure. The antenna 800 may be an antenna of a base station (e.g., any of the base stations described herein) or a UE (e.g., any of the UEs described herein). In the example of FIG. 8, the antenna 800 has four antenna panels 810-1, 810-2, 810-3, and 810-4 (collectively, antenna panels 810). Each antenna panel has four antenna elements 812-1, 812-2, 812-3, and 812-4 (collectively, antenna elements 812).

Each antenna panel 810 is capable of forming a receive and/or transmit beam in some predefined bore directions. In the example of FIG. 8, the antenna panel 810-1 forms a beam 820-1 (transmit or receive), the antenna panel 810-2 forms a beam 820-2 (transmit or receive), the antenna panel 810-3 forms a beam 820-3 (transmit or receive), and the antenna panel 810-4 forms a beam 820-4 (transmit or receive). As will be appreciated, the antenna panels 810 may not all form beams simultaneously, as shown in FIG. 8. As an example, the antenna 800 may be the antenna of a UE, the beams 820 may be downlink receive beams, and the UE may be attempting to receive the same (or different) PRS resource(s) on the beams 820.

Where the antenna 800 is a UE antenna, each antenna panel 810 is connected to its own uplink transmit chain and/or downlink receive chain. Where the antenna 800 is a base station antenna, each antenna panel 810 is connected to its own downlink transmit chain and/or uplink receive chain. An RF chain (whether receive or transmit) is a cascade of electronic components, such as amplifiers (e.g., low noise amplifiers (LNAs) for receive chains and power amplifiers (PAs) for transmit chains), filters, mixers, attenuators, and detectors, configured to receive an incoming analog signal (in the case of a receive chain) or transmit an outgoing analog signal (in the case of a transmit chain). Each receive chain is coupled to at least one antenna panel 810 on one end and an analog-to-digital converter (ADC) on the other. Each transmit chain is coupled to an antenna panel 810 on one end and a digital-to-analog converter (DAC) on the other.

Each uplink and downlink chain has its own group delay, which is the delay between a measured transmission or reception time of a signal and the actual time the signal is transmitted or received at the antenna panel. Each uplink and downlink chain also has its own processing errors, Tx timing errors, and Rx timing errors, which may be based in part on group delay. As noted above, classification of Tx and Rx timing errors into groups forms the Rx and Tx TEGs at both the base station and UE sides. Thus, as shown in FIG. 8, each antenna panel 810 is associated with a TEG, labeled “TEG1” to “TEG4.” As such, the measurement of a PRS resource received on beam 820-1 will be associated with TEG1, the measurement of a PRS resource (the same or different) received on beam 820-2 will be associated with TEG2, and so on.

Note that while FIG. 8 illustrates each antenna panel 810 as having a different TEG, it may be that all of the antenna panels 810 have the same TEG, or groups of antenna panels 810 may have the same TEG.

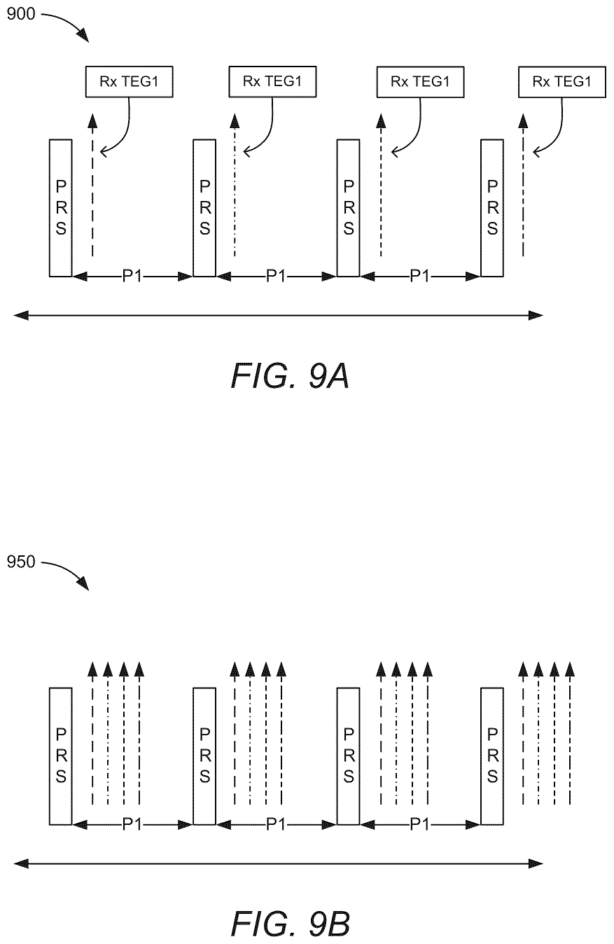

The present disclosure includes signaling a UE's processing capabilities with respect to multiple Rx/Tx TEG measurements (i.e., the Rx/Tx TEGs associated with PRS measurements, where “Rx/Tx” means Rx, Tx, or both Rx and Tx) for a positioning session with a network entity. FIGS. 9A and 9B illustrate different Rx TEG processing capabilities of a UE, according to aspects of the disclosure. In the examples of FIGS. 9A and 9B, time is represented horizontally and a PRS resource (labeled “PRS”) is transmitted over at least four occasions (i.e., there are at least four repetitions of the PRS resource). In both illustrated scenarios, the UE has four Rx TEGs for processing, represented by vertical arrows and differentiated by dash type. That is, there are four Rx TEGs that may be associated with a positioning measurement of a single PRS resource. For example, as in FIG. 8, the UE may have four antenna panels, each associated with its own Rx TEG, and the UE may receive the PRS resource on each of those antenna panels. As such, each measurement of the PRS resource would be associated with a different TEG. The location server may request that the UE provide a PRS measurement of the PRS resource for each of its TEGs.

In scenario 900 of FIG. 9A, the UE has the capability to process only one Rx TEG per repetition of the PRS resource (e.g., per measurement occasion). For example, with reference to FIG. 8, the UE can only measure the PRS resource on one antenna panel 810 at a time. This may be due to RF front end limitations of the UE, UE processing power, and/or the like. In this scenario, the UE needs to perform PRS measurements for all of the TEGs in a round robin fashion. For example, with reference to FIG. 8, the UE would measure the PRS resource on each antenna panel 810 in a round robin fashion. As such, the UE will need four repetitions of the PRS resource (e.g. four measurement occasions) to complete the measurements across all four TEGs. This is illustrated by a vertical arrow representing a TEG after each PRS resource repetition. The UE can transmit the measurement report (e.g., an LPP Provide Location Information message as at stage 660) only after the four measurement occasions.

In scenario 950 of FIG. 9B, the UE has the capability to process four Rx TEGs at a given time (e.g., per measurement occasion). For example, with reference to FIG. 8, the UE can measure the PRS resource on all four antenna panels 810 at the same time. This may be due to RF front end capabilities of the UE, UE processing power, and/or the like. In this scenario, the UE is able to perform PRS measurements for all the TEGs in one measurement occasion. For example, with reference to FIG. 8, the UE would measure the PRS resource on each antenna panel 810 in one repetition of the PRS resource (e.g., one measurement occasion). As such, the UE only needs a single measurement occasion to complete the measurements across all four TEGs. This is illustrated by four vertical arrows after each PRS resource repetition, one for each TEG. In this case, the UE can transmit a measurement report (e.g., an LPP Provide Location Information message as at stage 660) after each of the four measurement occasions.

In an aspect, to inform the location server of its TEG-related capabilities, a UE can provide the following capability information to the location server (e.g., in the LPP Provide Capabilities message at stage 620): (1) the number of Rx TEGs supported per PFL, (2) the number of Tx TEGs supported per PFL, (3) the number of (Rx, Tx) TEG pairs supported per PFL, (4) the number of Rx-Tx TEGs supported per PFL, (5) the number of simultaneous processing of Rx TEG per PFL, (6) the number of simultaneous transmission of Tx TEG per PFL, (7) the number of simultaneous processing of (Rx, Tx) TEG pairs per PFL, and/or (8) the number of simultaneous processing of Rx-Tx TEGs per PFL. Note that an (Rx, Tx) TEG pair means that the Rx TEG and the Tx TEG are the same. In contrast, an Rx-Tx TEG does not indicate what the Rx TEG or the Tx TEG is; it simply provides information on the combined group delay/timing error (that includes timing error due to Rx and Tx).

Simultaneous processing of Rx/Tx TEGs means the ability of the UE to receive/transmit a PRS/SRS resource using multiple antennas (and therefore multiple Rx/Tx TEGs) in a single PRS/SRS instance (repetition).

During the positioning session, the UE measures PRS resources during a “measurement gap,” also known as a “measurement instance” or “measurement occasion.” An example measurement period formulation for an RSTD measurement is:

$${T}_{RSTD , Total} = {\sum }_{i = 1}^{L} {T}_{RSTD , i} + ( L - 1 ) * max ( {T}_{effect , i} )$$

$${T}_{RSTD , i} = ( {CSSF}_{PRS , i} * {N}_{RxBeam , i} * ⌈ \frac{{N}_{PRS , i}^{slot}}{{N}_{i}^{′}} ⌉ ⌈ \frac{{L}_{avaliable \_ PRS , i}}{{N}_{i}} ⌉ * {N}_{sample} - 1 ) * {T}_{effect , i} + {T}_{last}$$

In connection with the variables used in these formulae:

$${CSSF}_{PRS , i} * {N}_{RxBeam , i} * ⌈ \frac{{N}_{PRS , i}^{slot}}{{N}_{i}^{′}} ⌉ ⌈ \frac{{L}_{avaliable \_ PRS , i}}{{N}_{i}} ⌉ * {N}_{sample}$$

corresponds to the total number of samples that are needed to be measured, wherein a sample corresponds to all the PRS resources within an effective period, denoted as T_{effect,i}. Further, for the last sample, the UE requires Tₗₐₛₜ=Tᵢ+T_{available_PRS,i}, where Tᵢ corresponds to the reported UE capability related to PRS processing.
The variables are determined based on the following factors:
CSSF_{PRS,i} is a factor that is used to control how each Measurement Gap is being shared between Positioning & mobility (RRM) measurements. If the factor is 1 it means that there is no sharing of the MG instances between the Positioning and the RRM measurements.
N_{rxbeam} is the Rx beam sweeping factor, which takes the value 8 for FR2 and 1 for FR1. A factor of 8 in the above formulation was agreed under the conservative assumption that the UE will perform up to 8 Rx beam sweeps across 8 “group of instances/samples” assuming the UE is keeping a constant Rx beam within each “group of instances/samples.”

$$⌈ \frac{{N}_{PRS , i}^{slot}}{{N}_{i}^{′}} ⌉ ⌈ \frac{{L}_{avaliable \_ PRS , i}}{{N}_{i}} ⌉$$

are the factors that consider the PRS processing UE capability with regards to the current PFL configuration. Assuming the UE's capabilities are large enough, these factors will be 1, and will not contribute to the latency.
Nₛₐₘₚₗₑ is the number of samples/instances (e.g., for a PRS with a periodicity of X msec, it is assumed that at least Nₛₐₘₚₗₑ of periods are needed).
T_{effect,i} corresponds to an effective measurement periodicity (which is derived using the MGRP, T_{PRS,i} and UE's reported capability Tᵢ)

$${T}_{effect , i} = ⌈ \frac{{T}_{i}}{{T}_{avaliable \_ PRS , i}} ⌉ * {T}_{avaliable \_ PRS , i} ,$$

where

T_{available_PRS,i}=LCM(T_{PRS,i},MGRPᵢ)
which considers the alignment of the measurement gap periodicity and the PRS periodicity.
Tₗₐₛₜ is the measurement duration for the last PRS RSTD sample, including the sampling time and processing time, Tₗₐₛₜ=Tᵢ+T_{available_PRS,i}.

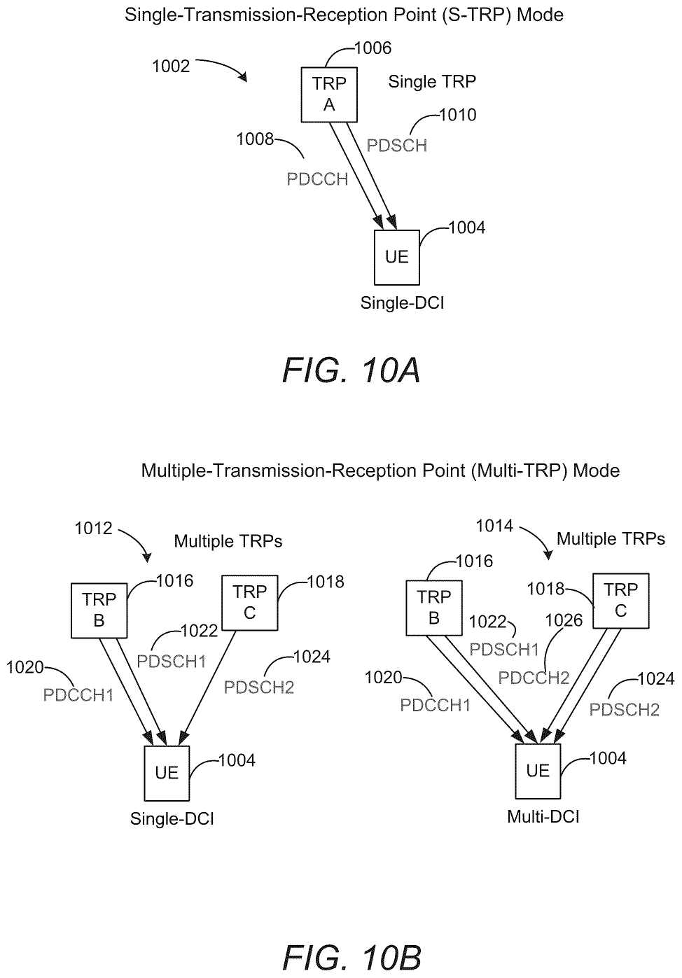

A UE may operate in different TRP modes corresponding to whether the UE is communicating with a single TRP or with multiple TRPs. Each TRP mode has a different configuration in which the UE exhibits different resource and/or processing capabilities. FIG. 10A shows a single-transmission-reception point (S-TRP) mode configuration 1002 in which the UE 1004 is in communication with a single TRP 1006 (labeled “TRP A”), according to aspects of the disclosure. In the S-TRP mode, TRP A 1006 provides the UE 1004 with information such as physical layer resource allocation, power control commands, and HARQ information for both uplink and downlink using the single-DCI transmitted via PDCCH 1008. Data is communicated from TRP A 1006 to the UE 1004 via PDSCH 1010. In the S-TRP mode, the UE need only exercise the processing capabilities and resource capabilities required to receive control and data communications from TRP A 1006 over a single PDCCH 1008 and a single PDSCH 1010.

The UE 1004 may also operate in a multiple transmission-reception point (multi-TRP) mode in which the UE 1004 is configured for communicating with multiple TRPs. Two such multi-TRP mode configurations are shown in FIG. 10B, according to aspects of the disclosure.

There are various scenarios in which it is advantageous to configure the UE 1004 for the multi-TRP mode of operation. One such scenario is when the UE 1004 is in a cell edge condition in which the UE 1004 is located at the periphery of multiple cells where it may experience high intercell interference (ICI). Another such scenario occurs when the reliability of the ultra-reliable low latency communication (URLLC) and/or vehicle-to-everything (V2X) latency of the UE 1004 is important. The configuration information specific to the multi-TRP mode may be provided to the UE 1004 in one or more RRC configuration messages.

Different multi-TRP modes are defined based on whether the UE 1004 receives a single DCI from a single TRP (multi-TRP, single-DCI) or multiple DCIs from multiple TRPs (multi-TRP, multi-DCI). FIG. 10B shows examples of both a multi-TRP, single-DCI configuration 1012 and a multi-TRP, multi-DCI configuration 1014, according to aspects of the disclosure. In the multi-TRP, single-DCI configuration 1012, a single DCI is received via a single PDCCH (PDCCH1 1020 from TRP A 1016) that schedules separate data layers received from separate TRPs (PDSCH1 1022 from TRP A 1016 and PDSCH2 1024 from TRP B 1018). In certain aspects, codeword (CW) to layer mapping and DMRS port indication may be specified for the multi-TRP, single-DCI configuration 1012. Note that transport blocks are converted into codewords using encoding defined for the given channel.

Multi-TRP, single-DCI operation may be employed where there is a high-quality backhaul between the involved TRPs, shown here as TRP 1016 (labeled TRP B) and TRP 1018 (labeled TRP C). A high-quality backhaul employs highly detailed feedback and close coordination between the involved TRPs. The multi-TRP, single-DCI mode may employ different PDSCH schemes for robustness, such as spatial domain multiplexing (SDM), frequency division multiplexing (FDM), and/or time division multiplexing (TDM).

The multi-TRP, multi-DCI configuration 1014 may be used with both high-quality and non-ideal backhaul cases. In the case of a non-ideal backhaul, joint scheduling among the involved TRPs may not be feasible due to delay of the coordination of control signals and/or data packets among the different TRPs. Alternatively, or additionally, there may be limited backhaul capacity between the TRPs, resulting in a poor link adaptation (or performance loss). In multi-DCI-based multi-TRP operation, a carrier aggregation framework can be leveraged to treat different TRPs as different virtual component carriers from the perspective of the UE's capabilities.

As shown in FIG. 10B, the UE 1004 is in communication with two TRPs 1016 and 1018. In the multi-TRP, single-DCI configuration 1012, the UE 1004 receives PDCCH1 1020 (which carries DCI) from only one TRP 1016 (TRP B), but a PDSCH from both TRPs (shown as PDSCH1 1022 from TRP B 1016, and PDSCH2 1024 from TRP C 1018). In contrast, in the multi-TRP, multi-DCI configuration 1014, the UE 1004 receives two DCI, a first DCI from TRP B 1016 via PDCCH1 1020, and a second DCI from TRP C 1018 via PDCCH2 1024. More specifically, DCI transmitted in PDCCH1 1020 by TRP B 1016 schedules PDSCH1 1022, and DCI transmitted by the TRP C 1018 in PDCCH2 1026 schedules PDSCH2 1024. The aspects that may be specified for the multi-TRP, multi-DCI configuration 1014 may include 1) the UE procedure for PDCCH detection, 2) the MAC entity number per cell, 3) the HARQ process distinction, 4) the UL transmission for acknowledgment or negative acknowledgment (ACK/NACK), and 5) the data scrambling.

The UE 1004 may have different processing and resource capabilities that are dependent on the TRP mode in which the UE 1004 is operating. In the S-TRP mode configuration 1002 shown in FIG. 10A, the UE 1004 receives a PDCCH (PDCCH 1008) and PDSCH (PDSCH 1010) from a single TRP.

In the multi-TRP, single-DCI mode 1012 shown in FIG. 10B, the UE 1004 receives more channels and uses more of the UE's processing capabilities than in the S-TRP mode 1002 shown in FIG. 10A. In the multi-TRP, single-DCI mode 1012, the UE 1004 receives a PDCCH (PDCCH1 1020) from a single TRP but also receives an additional PDSCH. More particularly, the UE 1004 receives a first PDSCH (PDSCH1 1022 from TRP B 1016) as well as a second PDSCH (PDSCH2 1024 from TRP C 1018). In certain aspects, the UE 1004 uses more of the UE's processing capabilities while in the multi-TRP, single-DCI mode than the processing capabilities used by the UE 1004 while operating in the S-TRP mode since the UE 1004 processes the additional PDSCH (PDSCH2 1024).

In the multi-TRP, multi-DCI mode configuration 1014 shown in FIG. 10B, the UE 1004 uses more of the UE's processing capabilities than in either the S-TRP mode 1002 shown in FIG. 10A or the multi-TRP, multi-DCI mode 1012 shown in FIG. 10B. In the multi-TRP, multi-DCI mode 1014, the UE 1004 receives and processes multiple PDCCH (PDCCH1 1020 from TRP B 1016 and PDCCH2 1026 from TRP C 1018) as well as receives and processes multiple PDSCHs (PDSCH1 1022 from TRP B 1016 and PDSCH2 1024 from TRP C 1018). In certain aspects, the UE 1004 uses more of the UE's processing capabilities while operating in the multi-TRP, multiple-DCI mode than compared to the processing capabilities used by the UE 1004 in the S-TRP mode since the UE 1004 processes the additional PDCCH (PDCCH1 1020) and additional PDSCHs (PDSCH1 1020 and PDSCH2 1024) compared to the operation of the UE 1004 in the S-TRP mode. Still further, the UE 1004 uses more of the UE's processing capabilities while operating in the multi-TRP mode, multiple-DCI mode compared to the processing capabilities used by the UE 1004 while operating in the multi-TRP, single-DCI mode since the UE 1004 processes the additional PDCCH (PDCCH2 1024) compared to the single PDCCH (PDCCH1 1020) processed in the multi-TRP, single-DCI mode.

With reference again to FIG. 6, a UE reports its positioning capabilities to a network entity (e.g., LMF 670) at the beginning of a positioning session. Typically, the UE reports its positioning capabilities based on the resource and processing configuration used in a nominally configured state (e.g., S-TRP mode configuration) of the UE. The positioning session is then conducted based on the resources and processing configuration used in the nominally configured state to reduce the power consumption of the UE during the positioning session.

Certain aspects of the disclosure, however, are implemented with a recognition that the resource and processing configurations used in the multi-TRP modes (single DCI and multi-DCI) are greater than the nominal resource and processing configuration used in the S-TRP mode. Certain aspects of the disclosure are also implemented with a recognition that any power savings associated with conducting a positioning session using nominally configured resource and processing capabilities are minimal in instances where the UE is already configured and operating in the multi-TRP mode at the start of the positioning session. Accordingly, in accordance with the aspects of the disclosure, where the UE is operating in the multi-TRP mode at the start of the positioning session, the UE may report a set of positioning capabilities for the positioning session that indicate one or more enhanced positioning capabilities of the UE to perform positioning operations based on the UE operating in the multi-TRP mode. In accordance with certain aspects of the disclosure, the one or more enhanced positioning capabilities are greater than one or more corresponding positioning capabilities of the UE to perform positioning operations based on the UE operating in the S-TRP mode. As such, the UE may use the increased resource and processing capabilities of the multi-TRP mode configuration to improve the number of resources that may be measured during a given measurement period (e.g., measurement gap, measurement instance, or measurement occasion).

In accordance with certain aspects, the multi-TRP mode of the UE may be deactivated or have its capabilities reduced during the positioning session. However, if the UE reported the set of positioning capabilities based on the enhanced positioning capabilities, the UE may maintain the enhanced positioning capabilities during the remaining portion of the positioning session to conduct the positioning operations using the enhanced positioning capabilities. This scenario may occur when the UE is in multi-TRP mode at the start of the positioning session and reports the higher processing capabilities to the LMF, but during the positioning session, the multi-TRP feature is disabled. Under ordinary circumstances, the UE capabilities automatically reduce to the capabilities associated with the S-TRP mode (e.g., a reduction in the number of data channels the UE can simultaneously receive, a reduction in the number of multiple carriers used by the UE, a reduction in number of neighboring cells measured by the UE, a reduction in the processing clock frequency used by the UE, etc.). However, if the UE begins the positioning session in the multi-TRP mode, the UE will keep operating using the higher processing capabilities reported to the LMF throughout the positioning session.

In certain aspects, the enhanced positioning capabilities are greater than corresponding positioning capabilities of the UE while operating in an S-TRP mode, such as the nominal resource and processing capabilities that exist when the UE operates in the S-TRP mode. In an aspect, the set of positioning capabilities may include enhanced PRS processing capabilities that are greater than the PRS processing capabilities of the UE in the S-TRP mode. Additionally, or in the alternative, the set of positioning capabilities may include enhanced PRS resource capabilities that are greater than the PRS resource capabilities of the UE in the S-TRP mode.

In certain aspects, the UE may have multiple antenna panels (e.g., as illustrated in FIG. 8). In such instances, the set of positioning capabilities may include enhanced positioning capabilities based on TEGs supported by the multiple panels, where the enhanced positioning capabilities based on TEGs supported by the multiple panels are greater than the positioning capabilities of TEGs supported by the multiple panels in the S-TRP mode. In an aspect, the UE may report the capability of measuring more TEGs, where the number of the TEGs is greater than that would be reported based on operation in the S-TRP mode.

Additionally, or in the alternative, the set of positioning capabilities may include an enhanced capability for measuring a first PRS resource based on different TEGs, where the enhanced capability of measuring the first PRS resource based on the different TEGs is greater than the capability for measuring the first PRS resource based on the different TEGs when the UE is operating in the S-TRP mode. In an aspect, while the multi-TRP feature is activated, the UE may report the capability to measure the same PRS resources with a greater number of TEGs compared to the case in which the multi-TRP feature is not activated.

Additionally, or in the alternative, the set of positioning capabilities may include an enhanced capability for measuring different PRS resources from TEGs having a first timing error margin, where the first error timing margin is less than a second timing error margin associated with measuring the different PRS resources from the TEGs in the S-TRP mode. In an aspect, two different PRS resources measured from the same TEG will have similar timing errors (e.g., errors within a timing margin of +/−X). In an aspect, a UE operating in the multi-TRP mode may report different timing margins for the TEGs than would otherwise be reported if the UE were operating in the S-TRP mode.

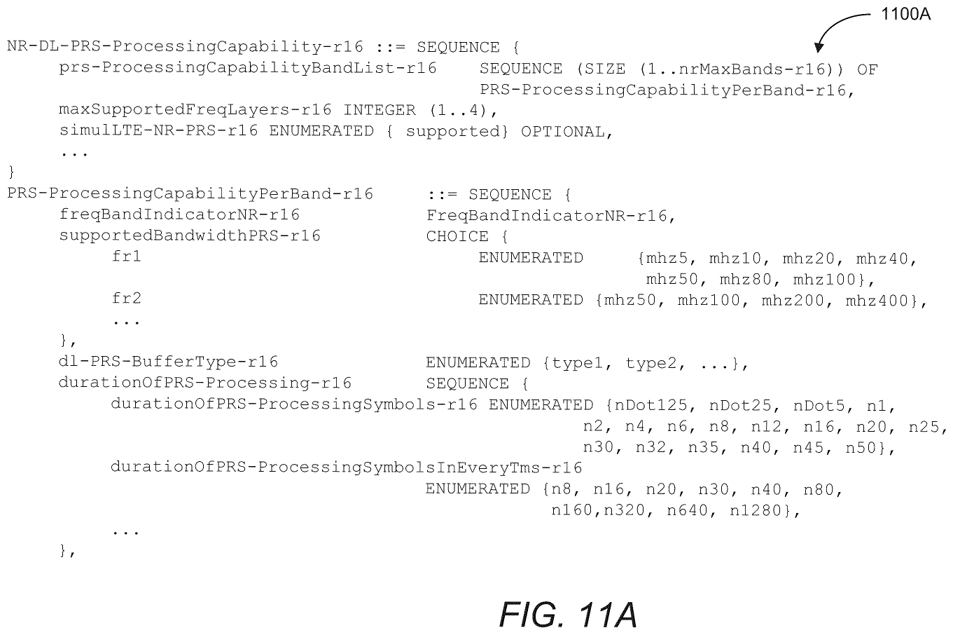

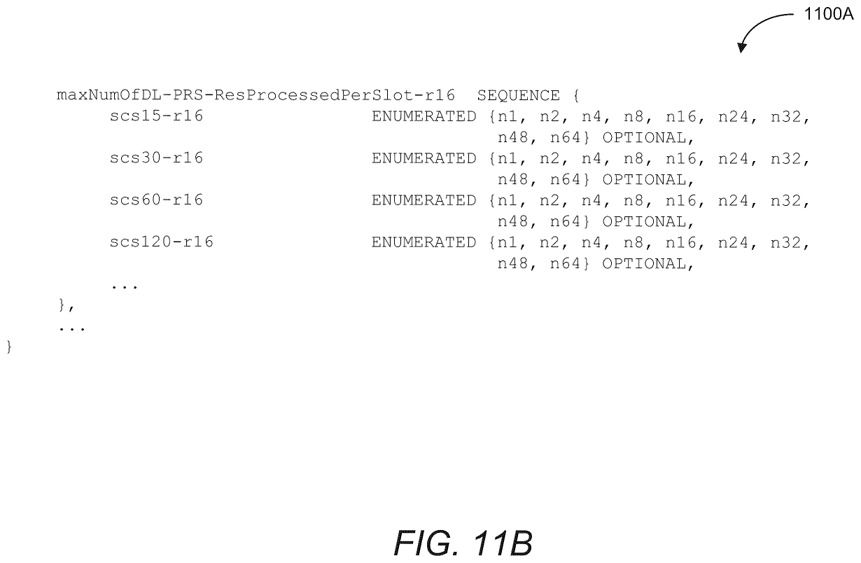

FIGS. 11A and 11B show an example set of IEs that may be used to indicate the PRS processing capabilities of the UE to a network entity (e.g., LMF 270) at the start of a positioning session (e.g., in an LPP Provide Capabilities message as at stage 620), according to aspects of the disclosure. A first portion of the example set is shown in FIG. 11A and is referenced as 1100A. A second portion of the example set is shown in FIG. 11B and is referenced as 1100B. In accordance with the aspects of the disclosure, the PRS processing capabilities reported in the IEs in the multi-TRP mode are enhanced (e.g., have values or other indicators of higher PRS processing capabilities) when compared to the processing capabilities reported in the IEs when the UE is in the S-TRP mode.

The NR-DL-PRS-ProcessingCapability IE defines the common DL-PRS Processing capability. In the case in which the UE has capabilities of using multiple NR positioning methods, the NR-DL-PRS-ProcessingCapability IE may apply across the NR positioning methods, and the UE may indicate the same values for the capabilities in the NR-DLTDOA-ProvideCapabilities IE, the NR-DL-AoD-ProvideCapabilities IE, and the NR-Multi-RTT-ProvideCapabilities IE. The NR-DL-PRS-ProcessingCapability IE may be defined for a single positioning frequency layer (i.e., a UE supporting multiple positioning frequency layers may be expected to process one frequency layer at a time). The maxSupportedFreqLayers IE may be used to indicate the maximum number of positioning frequency layers supported by the UE. The supportedBandwidthPRS IE may be used to indicate the maximum number of DL-PRS bandwidth in MHz, which is supported and reported by UE. The dl-PRS-BufferType IE may be used to indicate DL-PRS buffering capability, where the value type1 may be used to indicate sub-slot/symbol level buffering and the value type2 may be used to indicate slot level buffering.

The durationOfPRS-Processing IE may be used to indicate the duration N of DL-PRS symbols (in units of ms) a UE can process every T ms assuming the maximum DL-PRS bandwidth provided in the supportedBandwidthPRS IE. The durationOfPRS-Processing IE may include a durationOfPRS-ProcessingSymbols field specifying the enumerated values for N indicated as 0.125, 0.25, 0.5, 1, 2, 4, 8, 12, 16, 20, 25, 30, 35, 40, 45, or 50 ms. The durationOfPRS-Processing IE may also include a durationOfPRS-ProcessingSymbolsInEveryTms field specifying the enumerated values for T indicated as 8, 16, 20, 30, 40, 80, 160, 320, 640, 1280 ms.

The maxNumOfDL-PRS-ResProcessedPerSlot IE may be used to indicate the maximum number of DL-PRS resources that the UE can process in a slot. SCSs of 15 kHz, 30 kHz, and 60 kHz are applicable for FR1 bands while SCSs of 60 kHz and 120 KHz are applicable for FR2 bands.

The simulLTE-NR-PRS IE may be used to indicate whether the UE supports parallel processing of LTE PRS and NR PRS.

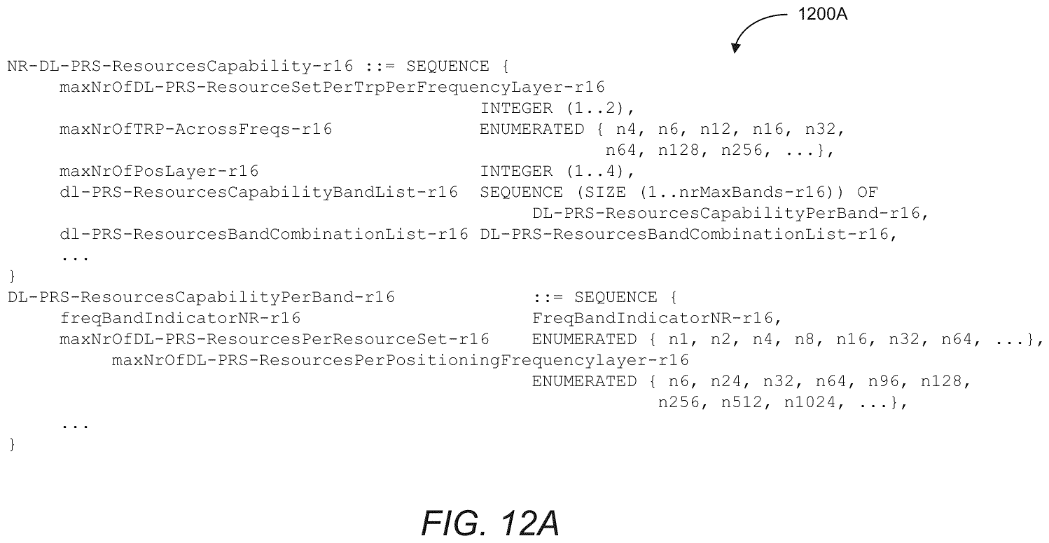

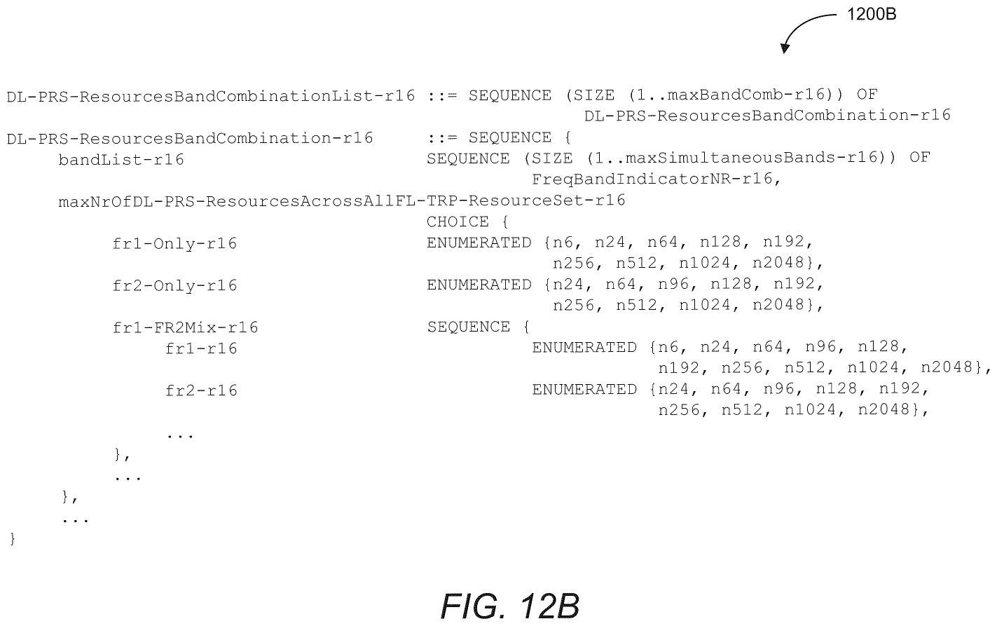

FIGS. 12A and 12B show an example set of IEs that may be used to indicate the PRS resource capabilities of the UE to a network entity at the start of a positioning session, according to aspects of the disclosure. A first portion of the example set is shown in FIG. 12A and is referenced as 1200A. A second portion of the example set is shown in FIG. 12B and is referenced as 1200B. The NR-DL-PRS-ResourcesCapability IE defines the DL-PRS resources capability for each positioning method. The UE can use this IE if the UE supports the NR-DL-PRS-ProcessingCapability IE. Otherwise, the UE need not include this IE and its positioning capability reporting.

The NR-DL-PRS-ResourcesCapability IE may include a number of fields. In the example set, the maxNrOfDL-PRS-ResourceSetPerTrpPerFrequencyLayer field may be used to indicate the maximum number of DL-PRS Resource Sets per TRP per frequency layer supported by the UE. The maxNrOfTRP-AcrossFreqs field may be used to indicate the maximum number of TRPs across all positioning frequency layers supported by the UE. The maxNrOfPosLayer field may be used to indicate the maximum number of positioning layers supported by the UE.

The dl-PRS-ResourcesBandCombinationList field may be used to provide the capabilities of DL-PRS Resources for the indicated band combination in bandList. This field may be provided for all band combinations for which the UE supports DL-PRS.

With respect to the remaining fields of the NR-DL-PRS-ResourcesCapability IE, the maxNrOfDL-PRS-ResourcesPerResourceSet field may be used to indicate the maximum number of DL-PRS Resources per DL-PRS Resource Set supported by the UE. The maxNrOfDL-PRS-ResourcesPerPositioningFrequencylayer field may be used to indicate the maximum number of DL-PRS resources per TRP across all frequency layers supported by the UE. The maxNrOfDL-PRS-ResourcesAcrossAllFL-TRP-ResourceSet field may be used to indicate the maximum number of DL-PRS Resources supported by the UE across all frequency layers, TRPs, and DL-PRS.

In accordance with certain aspects of the disclosure, the UE may schedule the number of PRS resources measured during the measurement gap, measurement occasion, or measurement instances based on whether the UE is operating in the multi-TRP mode or S-TRP mode instance during the positioning session. With the UE operating in the multi-TRP mode, the UE may be able to measure more PRS resources in the given measurement gap, measurement occasion, or measurement window. For example, while the UE is operating in the S-TRP mode, the UE may have the capability of measuring K PRS resources during each gap, instance, or occasion. In contrast, the UE will be capable of measuring K+N PRS resources during the same gap, instance, or occasion while operating in the multi-TRP mode.

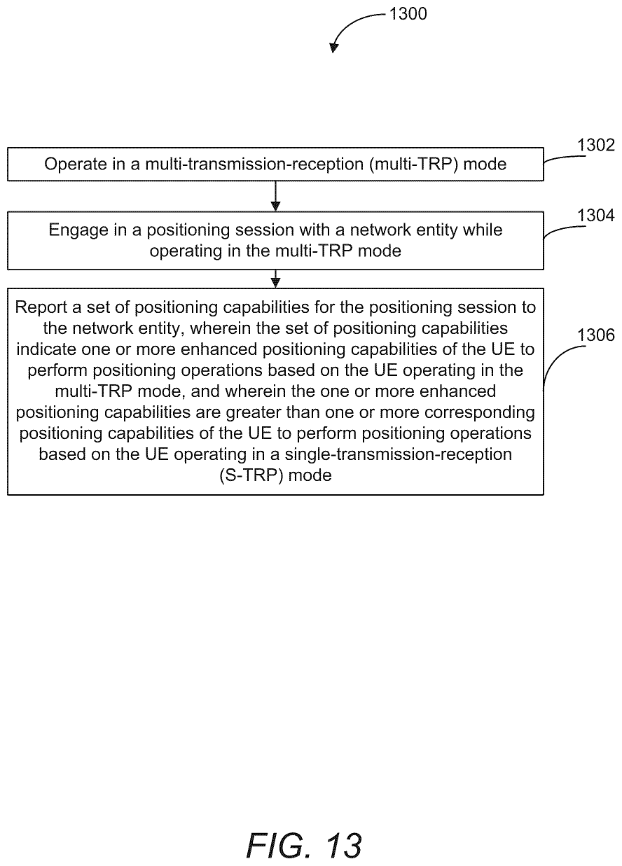

FIG. 13 illustrates an example method 1300 of wireless communication performed by a user equipment (UE), according to aspects of the disclosure. At operation 1302, the UE operates in a multi-transmission-reception (multi-TRP) mode. In an aspect, operation 1302 may be performed by the one or more WWAN transceivers 310, the one or more processors 332, memory 340, and/or positioning component 342, any or all of which may be considered means for performing this operation.

At operation 1304, the UE engages in a positioning session with a network entity while operating in the multi-TRP mode. In an aspect, operation 1304 may be performed by the one or more WWAN transceivers 310, the one or more processors 332, memory 340, and/or positioning component 342, any or all of which may be considered means for performing this operation.

At operation 1306, the UE reports a set of positioning capabilities for the positioning session to the network entity, wherein the set of positioning capabilities indicate one or more enhanced positioning capabilities of the UE to perform positioning operations based on the UE operating in the multi-TRP mode, and wherein the one or more enhanced positioning capabilities are greater than one or more corresponding positioning capabilities of the UE to perform positioning operations based on the UE operating in a single-transmission-reception (S-TRP) mode. In an aspect, operation 1306 may be performed by the one or more WWAN transceivers 310, the one or more processors 332, memory 340, and/or positioning component 342, any or all of which may be considered means for performing this operation.

As will be appreciated, a technical advantage of the method 1300 is that the UE may report a set of positioning capabilities for the positioning session that indicate one or more enhanced positioning capabilities of the UE to perform positioning operations based on the UE operating in the multi-TRP mode. The one or more enhanced positioning capabilities are greater than one or more corresponding positioning capabilities of the UE to perform positioning operations based on the UE operating in a single-transmission-reception (S-TRP) mode. As such, the UE may use the increased resource and processing capabilities of the multi-TRP mode configuration to improve the UE measurement period and reduce latency for positioning.

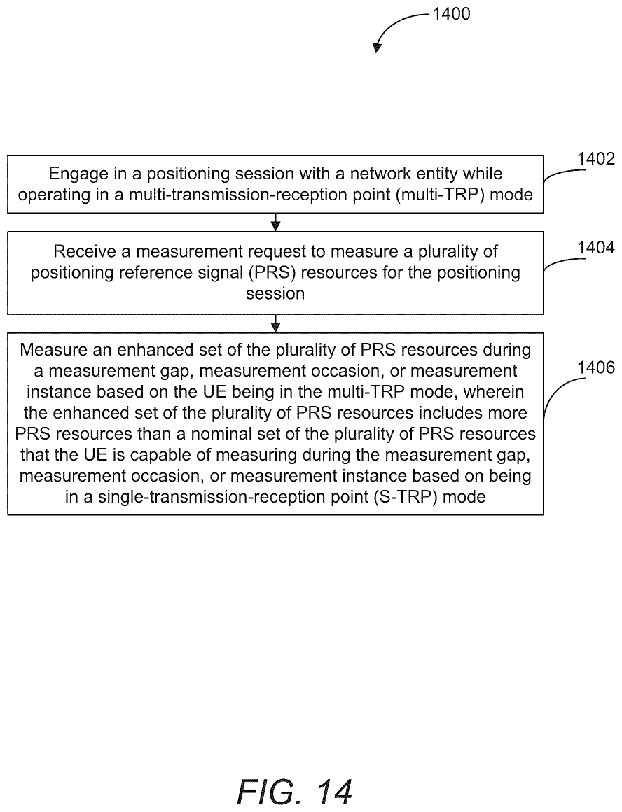

FIG. 14 illustrates an example method 1400 of wireless communication performed by a user equipment (UE), according to aspects of the disclosure. At operation 1402, the UE engages in a positioning session with a network entity while operating in a multi-transmission-reception point (multi-TRP) mode. In an aspect, operation 1402 may be performed by the one or more WWAN transceivers 310, the one or more processors 332, memory 340, and/or positioning component 342, any or all of which may be considered means for performing this operation.

At operation 1404, the UE receives a measurement request to measure a plurality of positioning reference signal (PRS) resources for the positioning session. In an aspect, operation 1404 may be performed by the one or more WWAN transceivers 310, the one or more processors 332, memory 340, and/or positioning component 342, any or all of which may be considered means for performing this operation.

At operation 1406, the UE measures an enhanced set of the plurality of PRS resources during a measurement gap, measurement occasion, or measurement instance based on the UE being in the multi-TRP mode, wherein the enhanced set of the plurality of PRS resources includes more PRS resources than a nominal set of the plurality of PRS resources that the UE is capable of measuring during the measurement gap, measurement occasion, or measurement instance based on being in a single-transmission-reception point (S-TRP) mode. In an aspect, operation 1406 may be performed by the one or more WWAN transceivers 310, the one or more processors 332, memory 340, and/or positioning component 342, any or all of which may be considered means for performing this operation.

As will be appreciated, a technical advantage of the method 1400 is that the UE may measure more PRS resources within a given measurement gap, measurement occasion, or measurement instance while operating in the multi-TRP mode than the UE could otherwise measure during a nominally configured mode, such as the S-TRP mode. Further, providing a measurement report more quickly may improve the time to first fix of the UE's position.

In the detailed description above, it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a user equipment (UE), comprising: operating in a multi-transmission-reception point (multi-TRP) mode: engaging in a positioning session with a network entity while operating in the multi-TRP mode; and reporting a set of positioning capabilities for the positioning session to the network entity, wherein the set of positioning capabilities indicate one or more enhanced positioning capabilities of the UE to perform positioning operations based on the UE operating in the multi-TRP mode, and wherein the one or more enhanced positioning capabilities are greater than one or more corresponding positioning capabilities of the UE to perform positioning operations based on the UE operating in a single-transmission-reception point (S-TRP) mode.

Clause 2. The method of clause 1, further comprising: deactivating the multi-TRP mode during the positioning session; and maintaining the one or more enhanced positioning capabilities for a remainder of the positioning session.

Clause 3. The method of any of clauses 1 to 2, further comprising: reducing one or more capabilities of the multi-TRP mode during the positioning session; and maintaining the one or more enhanced positioning capabilities for a remainder of the positioning session.

Clause 4. The method of any of clauses 1 to 3, wherein: the one or more enhanced positioning capabilities include one or more enhanced positioning reference signal (PRS) processing capabilities, and the one or more enhanced PRS processing capabilities are greater than PRS processing capabilities of the UE in the S-TRP mode.

Clause 5. The method of any of clauses 1 to 4, wherein: the UE comprises multiple antenna panels, the one or more enhanced positioning capabilities include at least one enhanced positioning capability based on timing error groups (TEGs) supported by the multiple antenna panels, and the at least one enhanced positioning capability is based on TEGs supported by the multiple antenna panels being greater than positioning capabilities of TEGs supported by the multiple antenna panels in the S-TRP mode.

Clause 6. The method of any of clauses 1 to 5, wherein: the UE comprises multiple antenna panels, and the one or more enhanced positioning capabilities includes at least one enhanced capability for measuring a first PRS resource based on different TEGs, and the at least one enhanced capability of measuring the first PRS resource based on the different TEGs is greater than a capability of measuring the first PRS resource based on the different TEGs in the S-TRP mode.

Clause 7. The method of any of clauses 1 to 6, wherein: the UE comprises multiple antenna panels, the one or more enhanced positioning capabilities includes at least one enhanced capability for measuring different PRS resources from TEGs having a first timing error margin, and the first error timing margin is less than a second timing error margin associated with measuring the different PRS resources from the TEGs in the S-TRP mode.

Clause 8. The method of any of clauses 1 to 7, wherein engaging in the positioning session with the network entity comprises: receiving assistance data from the network entity, wherein the assistance data indicates one or more PRS resources to be measured for the positioning session; and reporting, to the network entity, one or more measurements of the one or more PRS resources indicated in the assistance data.

Clause 9. The method of any of clauses 1 to 8, wherein operating in the S-TRP mode comprises: receiving one or more physical download control channels (PDCCHs) carrying downlink control information (DCI) from a single TRP; and receiving one or more physical download shared channels (PDSCHs) from the single TRP.

Clause 10. The method of any of clauses 1 to 9, wherein operating in the multi-TRP mode comprises: receiving a PDCCH carrying DCI from a single TRP; and receiving multiple PDSCHs from multiple TRPs.

Clause 11. The method of any of clauses 1 to 9, wherein operating in the multi-TRP mode comprises: receiving multiple PDCCHs from multiple TRPs, wherein each of the multiple PDCCHs carry respective DCIs; and receiving multiple physical download shared channels (PDSCHs) from the multiple TRPs.

Clause 12. The method of any of clauses 1 to 11, wherein: the network entity is a location server, and the set of positioning capabilities for the positioning session are reported to the location server in one or more Long-Term Evolution (LTE) positioning protocol (LPP) messages.

Clause 13. A method of wireless communication performed by a user equipment (UE), comprising: engaging in a positioning session with a network entity while operating in a multi-transmission-reception point (multi-TRP) mode; receiving a measurement request to measure a plurality of positioning reference signal (PRS) resources for the positioning session; and measuring an enhanced set of the plurality of PRS resources during a measurement period based on the UE being in the multi-TRP mode, wherein the enhanced set of the plurality of PRS resources includes more PRS resources than a nominal set of the plurality of PRS resources that the UE is capable of measuring during the measurement period, measurement occasion, or measurement instance while operating in a single-transmission-reception point (S-TRP) mode.

Clause 14. The method of clause 13, wherein operating in the S-TRP mode comprises: receiving one or more physical download control channels (PDCCHs) carrying downlink control information (DCI) from a single TRP; and receiving one or more physical download shared channels (PDSCHs) from the single TRP.

Clause 15. The method of any of clauses 13 to 14, wherein operating in the multi-TRP mode comprises: receiving a PDCCH carrying DCI from a single TRP; and receiving multiple PDSCHs from multiple TRPs.

Clause 16. The method of any of clauses 13 to 14, wherein operating in the multi-TRP mode comprises: receiving multiple PDCCHs from multiple TRPs, wherein each of the multiple PDCCHs carry respective DCIs; and receiving multiple physical download shared channels (PDSCHs) from the multiple TRPs.

Clause 17. The method of any of clauses 13 to 16, wherein: the network entity is a location server, and the measurement request is received from the location server in one or more Long-Term Evolution (LTE) positioning protocol (LPP) messages.

Clause 18. A user equipment (UE), comprising: a memory; at least one transceiver; and at least one processor communicatively coupled to the memory and the at least one transceiver, the at least one processor configured to: operate in a multi-transmission-reception point (multi-TRP) mode; engage in a positioning session with a network entity while operating in the multi-TRP mode; and report, via the at least one transceiver, a set of positioning capabilities for the positioning session to the network entity, wherein the set of positioning capabilities indicate one or more enhanced positioning capabilities of the UE to perform positioning operations based on the UE operating in the multi-TRP mode, and wherein the one or more enhanced positioning capabilities are greater than one or more corresponding positioning capabilities of the UE to perform positioning operations based on the UE operating in a single-transmission-reception point (S-TRP) mode.

Clause 19. The UE of clause 18, wherein the at least one processor is further configured to: deactivate the multi-TRP mode during the positioning session; and maintain the one or more enhanced positioning capabilities for a remainder of the positioning session.

Clause 20. The UE of any of clauses 18 to 19, wherein the at least one processor is further configured to: reduce one or more capabilities of the multi-TRP mode during the positioning session; and maintain the one or more enhanced positioning capabilities for a remainder of the positioning session.

Clause 21. The UE of any of clauses 18 to 20, wherein: the one or more enhanced positioning capabilities include one or more enhanced positioning reference signal (PRS) processing capabilities, and the one or more enhanced PRS processing capabilities are greater than PRS processing capabilities of the UE in the S-TRP mode.

Clause 22. The UE of any of clauses 18 to 21, wherein: the UE comprises multiple antenna panels, the one or more enhanced positioning capabilities include at least one enhanced positioning capability based on timing error groups (TEGs) supported by the multiple antenna panels, and the at least one enhanced positioning capability is based on TEGs supported by the multiple antenna panels being greater than positioning capabilities of TEGs supported by the multiple antenna panels in the S-TRP mode.

Clause 23. The UE of any of clauses 18 to 22, wherein: the UE comprises multiple antenna panels, and the one or more enhanced positioning capabilities includes at least one enhanced capability for measuring a first PRS resource based on different TEGs, and the at least one enhanced capability of measuring the first PRS resource based on the different TEGs is greater than a capability of measuring the first PRS resource based on the different TEGs in the S-TRP mode.

Clause 24. The UE of any of clauses 18 to 23, wherein: the UE comprises multiple antenna panels, the one or more enhanced positioning capabilities includes at least one enhanced capability for measuring different PRS resources from TEGs having a first timing error margin, and the first error timing margin is less than a second timing error margin associated with measuring the different PRS resources from the TEGs in the S-TRP mode.

Clause 25. The UE of any of clauses 18 to 24, wherein the at least one processor configured to engage in the positioning session with the network entity comprises the at least one processor configured to: receive, via the at least one transceiver, assistance data from the network entity, wherein the assistance data indicates one or more PRS resources to be measured for the positioning session; and report, via the at least one transceiver, to the network entity, one or more measurements of the one or more PRS resources indicated in the assistance data.

Clause 26. The UE of any of clauses 18 to 25, wherein the at least one processor configured to operate in the S-TRP mode comprises the at least one processor configured to: receive, via the at least one transceiver, one or more physical download control channels (PDCCHs) carrying downlink control information (DCI) from a single TRP; and receive, via the at least one transceiver, one or more physical download shared channels (PDSCHs) from the single TRP.

Clause 27. The UE of any of clauses 18 to 26, wherein the at least one processor configured to operate in the multi-TRP mode comprises the at least one processor configured to: receive, via the at least one transceiver, a PDCCH carrying DCI from a single TRP; and receive, via the at least one transceiver, multiple PDSCHs from multiple TRPs.

Clause 28. The UE of any of clauses 18 to 26, wherein the at least one processor configured to operate in the multi-TRP mode comprises the at least one processor configured to: receive, via the at least one transceiver, multiple PDCCHs from multiple TRPs, wherein each of the multiple PDCCHs carry respective DCIs; and receive, via the at least one transceiver, multiple physical download shared channels (PDSCHs) from the multiple TRPs.

Clause 29. The UE of any of clauses 18 to 28, wherein: the network entity is a location server, and the set of positioning capabilities for the positioning session are reported to the location server in one or more Long-Term Evolution (LTE) positioning protocol (LPP) messages.

Clause 30. A user equipment (UE), comprising: a memory; at least one transceiver; and at least one processor communicatively coupled to the memory and the at least one transceiver, the at least one processor configured to: engage in a positioning session with a network entity while operating in a multi-transmission-reception point (multi-TRP) mode: receive, via the at least one transceiver, a measurement request to measure a plurality of positioning reference signal (PRS) resources for the positioning session; and measure an enhanced set of the plurality of PRS resources during a measurement period based on the UE being in the multi-TRP mode, wherein the enhanced set of the plurality of PRS resources includes more PRS resources than a nominal set of the plurality of PRS resources that the UE is capable of measuring during the measurement period, measurement occasion, or measurement instance while operating in a single-transmission-reception point (S-TRP) mode.

Clause 31. The UE of clause 30, wherein the at least one processor configured to operate in the S-TRP mode comprises the at least one processor configured to: receive, via the at least one transceiver, one or more physical download control channels (PDCCHs) carrying downlink control information (DCI) from a single TRP; and receive, via the at least one transceiver, one or more physical download shared channels (PDSCHs) from the single TRP.

Clause 32. The UE of any of clauses 30 to 31, wherein the at least one processor configured to operate in the multi-TRP mode comprises the at least one processor configured to: receive, via the at least one transceiver, a PDCCH carrying DCI from a single TRP; and receive, via the at least one transceiver, multiple PDSCHs from multiple TRPs.

Clause 33. The UE of any of clauses 30 to 31, wherein the at least one processor configured to operate in the multi-TRP mode comprises the at least one processor configured to: receive, via the at least one transceiver, multiple PDCCHs from multiple TRPs, wherein each of the multiple PDCCHs carry respective DCIs; and receive, via the at least one transceiver, multiple physical download shared channels (PDSCHs) from the multiple TRPs.

Clause 34. The UE of any of clauses 30 to 33, wherein: the network entity is a location server, and the measurement request is received from the location server in one or more Long-Term Evolution (LTE) positioning protocol (LPP) messages.

Clause 35. A user equipment (UE), comprising: means for operating in a multi-transmission-reception point (multi-TRP) mode; means for engaging in a positioning session with a network entity while operating in the multi-TRP mode; and means for reporting a set of positioning capabilities for the positioning session to the network entity, wherein the set of positioning capabilities indicate one or more enhanced positioning capabilities of the UE to perform positioning operations based on the UE operating in the multi-TRP mode, and wherein the one or more enhanced positioning capabilities are greater than one or more corresponding positioning capabilities of the UE to perform positioning operations based on the UE operating in a single-transmission-reception point (S-TRP) mode.

Clause 36. The UE of clause 35, further comprising: means for deactivating the multi-TRP mode during the positioning session; and means for maintaining the one or more enhanced positioning capabilities for a remainder of the positioning session.

Clause 37. The UE of any of clauses 35 to 36, further comprising: means for reducing one or more capabilities of the multi-TRP mode during the positioning session; and means for maintaining the one or more enhanced positioning capabilities for a remainder of the positioning session.

Clause 38. The UE of any of clauses 35 to 37, wherein: the one or more enhanced positioning capabilities include one or more enhanced positioning reference signal (PRS) processing capabilities, and the one or more enhanced PRS processing capabilities are greater than PRS processing capabilities of the UE in the S-TRP mode.

Clause 39. The UE of any of clauses 35 to 38, wherein: the UE comprises multiple antenna panels, the one or more enhanced positioning capabilities include at least one enhanced positioning capability based on timing error groups (TEGs) supported by the multiple antenna panels, and the at least one enhanced positioning capability is based on TEGs supported by the multiple antenna panels being greater than positioning capabilities of TEGs supported by the multiple antenna panels in the S-TRP mode.

Clause 40. The UE of any of clauses 35 to 39, wherein: the UE comprises multiple antenna panels, and the one or more enhanced positioning capabilities includes at least one enhanced capability for measuring a first PRS resource based on different TEGs, and the at least one enhanced capability of measuring the first PRS resource based on the different TEGs is greater than a capability of measuring the first PRS resource based on the different TEGs in the S-TRP mode.

Clause 41. The UE of any of clauses 35 to 40, wherein: the UE comprises multiple antenna panels, the one or more enhanced positioning capabilities includes at least one enhanced capability for measuring different PRS resources from TEGs having a first timing error margin, and the first error timing margin is less than a second timing error margin associated with measuring the different PRS resources from the TEGs in the S-TRP mode.

Clause 42. The UE of any of clauses 35 to 41, wherein the means for engaging in the positioning session with the network entity comprises: means for receiving assistance data from the network entity, wherein the assistance data indicates one or more PRS resources to be measured for the positioning session; and means for reporting, to the network entity, one or more measurements of the one or more PRS resources indicated in the assistance data.

Clause 43. The UE of any of clauses 35 to 42, wherein the means for operating in the S-TRP mode comprises: means for receiving one or more physical download control channels (PDCCHs) carrying downlink control information (DCI) from a single TRP; and means for receiving one or more physical download shared channels (PDSCHs) from the single TRP.

Clause 44. The UE of any of clauses 35 to 43, wherein the means for operating in the multi-TRP mode comprises: means for receiving a PDCCH carrying DCI from a single TRP; and means for receiving multiple PDSCHs from multiple TRPs.

Clause 45. The UE of any of clauses 35 to 43, wherein the means for operating in the multi-TRP mode comprises: means for receiving multiple PDCCHs from multiple TRPs, wherein each of the multiple PDCCHs carry respective DCIs; and means for receiving multiple physical download shared channels (PDSCHs) from the multiple TRPs.

Clause 46. The UE of any of clauses 35 to 45, wherein: the network entity is a location server, and the set of positioning capabilities for the positioning session are reported to the location server in one or more Long-Term Evolution (LTE) positioning protocol (LPP) messages.

Clause 47. A user equipment (UE), comprising: means for engaging in a positioning session with a network entity while operating in a multi-transmission-reception point (multi-TRP) mode: means for receiving a measurement request to measure a plurality of positioning reference signal (PRS) resources for the positioning session; and means for measuring an enhanced set of the plurality of PRS resources during a measurement period based on the UE being in the multi-TRP mode, wherein the enhanced set of the plurality of PRS resources includes more PRS resources than a nominal set of the plurality of PRS resources that the UE is capable of measuring during the measurement period, measurement occasion, or measurement instance while operating in a single-transmission-reception point (S-TRP) mode.

Clause 48. The UE of clause 47, wherein the means for operating in the S-TRP mode comprises: means for receiving one or more physical download control channels (PDCCHs) carrying downlink control information (DCI) from a single TRP; and means for receiving one or more physical download shared channels (PDSCHs) from the single TRP.

Clause 49. The UE of any of clauses 47 to 48, wherein the means for operating in the multi-TRP mode comprises: means for receiving a PDCCH carrying DCI from a single TRP; and means for receiving multiple PDSCHs from multiple TRPs.

Clause 50. The UE of any of clauses 47 to 48, wherein the means for operating in the multi-TRP mode comprises: means for receiving multiple PDCCHs from multiple TRPs, wherein each of the multiple PDCCHs carry respective DCIs; and means for receiving multiple physical download shared channels (PDSCHs) from the multiple TRPs.

Clause 51. The UE of any of clauses 47 to 50, wherein: the network entity is a location server, and the measurement request is received from the location server in one or more Long-Term Evolution (LTE) positioning protocol (LPP) messages.

Clause 52. A non-transitory computer-readable medium storing computer-executable instructions that, when executed by a user equipment (UE), cause the UE to: operate in a multi-transmission-reception point (multi-TRP) mode: engage in a positioning session with a network entity while operating in the multi-TRP mode; and report a set of positioning capabilities for the positioning session to the network entity, wherein the set of positioning capabilities indicate one or more enhanced positioning capabilities of the UE to perform positioning operations based on the UE operating in the multi-TRP mode, and wherein the one or more enhanced positioning capabilities are greater than one or more corresponding positioning capabilities of the UE to perform positioning operations based on the UE operating in a single-transmission-reception point (S-TRP) mode.

Clause 53. The non-transitory computer-readable medium of clause 52, further comprising computer-executable instructions that, when executed by the UE, cause the UE to: deactivate the multi-TRP mode during the positioning session; and maintain the one or more enhanced positioning capabilities for a remainder of the positioning session.

Clause 54. The non-transitory computer-readable medium of any of clauses 52 to 53, further comprising computer-executable instructions that, when executed by the UE, cause the UE to: reduce one or more capabilities of the multi-TRP mode during the positioning session; and maintain the one or more enhanced positioning capabilities for a remainder of the positioning session.

Clause 55. The non-transitory computer-readable medium of any of clauses 52 to 54, wherein: the one or more enhanced positioning capabilities include one or more enhanced positioning reference signal (PRS) processing capabilities, and the one or more enhanced PRS processing capabilities are greater than PRS processing capabilities of the UE in the S-TRP mode.

Clause 56. The non-transitory computer-readable medium of any of clauses 52 to 55, wherein: the UE comprises multiple antenna panels, the one or more enhanced positioning capabilities include at least one enhanced positioning capability based on timing error groups (TEGs) supported by the multiple antenna panels, and the at least one enhanced positioning capability is based on TEGs supported by the multiple antenna panels being greater than positioning capabilities of TEGs supported by the multiple antenna panels in the S-TRP mode.

Clause 57. The non-transitory computer-readable medium of any of clauses 52 to 56, wherein: the UE comprises multiple antenna panels, and the one or more enhanced positioning capabilities includes at least one enhanced capability for measuring a first PRS resource based on different TEGs, and the at least one enhanced capability of measuring the first PRS resource based on the different TEGs is greater than a capability of measuring the first PRS resource based on the different TEGs in the S-TRP mode.

Clause 58. The non-transitory computer-readable medium of any of clauses 52 to 57, wherein: the UE comprises multiple antenna panels, the one or more enhanced positioning capabilities includes at least one enhanced capability for measuring different PRS resources from TEGs having a first timing error margin, and the first error timing margin is less than a second timing error margin associated with measuring the different PRS resources from the TEGs in the S-TRP mode.

Clause 59. The non-transitory computer-readable medium of any of clauses 52 to 58, wherein the computer-executable instructions that, when executed by the UE, cause the UE to engage in the positioning session with the network entity comprise computer-executable instructions that, when executed by the UE, cause the UE to: receive assistance data from the network entity, wherein the assistance data indicates one or more PRS resources to be measured for the positioning session; and report, to the network entity, one or more measurements of the one or more PRS resources indicated in the assistance data.

Clause 60. The non-transitory computer-readable medium of any of clauses 52 to 59, wherein the computer-executable instructions that, when executed by the UE, cause the UE to operate in the S-TRP mode comprise computer-executable instructions that, when executed by the UE, cause the UE to: receive one or more physical download control channels (PDCCHs) carrying downlink control information (DCI) from a single TRP; and receive one or more physical download shared channels (PDSCHs) from the single TRP.

Clause 61. The non-transitory computer-readable medium of any of clauses 52 to 60, wherein the computer-executable instructions that, when executed by the UE, cause the UE to operate in the multi-TRP mode comprise computer-executable instructions that, when executed by the UE, cause the UE to: receive a PDCCH carrying DCI from a single TRP; and receive multiple PDSCHs from multiple TRPs.

Clause 62. The non-transitory computer-readable medium of any of clauses 52 to 60, wherein the computer-executable instructions that, when executed by the UE, cause the UE to operate in the multi-TRP mode comprise computer-executable instructions that, when executed by the UE, cause the UE to: receive multiple PDCCHs from multiple TRPs, wherein each of the multiple PDCCHs carry respective DCIs; and receive multiple physical download shared channels (PDSCHs) from the multiple TRPs.

Clause 63. The non-transitory computer-readable medium of any of clauses 52 to 62, wherein: the network entity is a location server, and the set of positioning capabilities for the positioning session are reported to the location server in one or more Long-Term Evolution (LTE) positioning protocol (LPP) messages.

Clause 64. A non-transitory computer-readable medium storing computer-executable instructions that, when executed by an UE, cause the UE to: engage in a positioning session with a network entity while operating in a multi-transmission-reception point (multi-TRP) mode; receive a measurement request to measure a plurality of positioning reference signal (PRS) resources for the positioning session; and measure an enhanced set of the plurality of PRS resources during a measurement period based on the UE being in the multi-TRP mode, wherein the enhanced set of the plurality of PRS resources includes more PRS resources than a nominal set of the plurality of PRS resources that the UE is capable of measuring during the measurement period, measurement occasion, or measurement instance while operating in a single-transmission-reception point (S-TRP) mode.

Clause 65. The non-transitory computer-readable medium of clause 64, wherein the computer-executable instructions that, when executed by the UE, cause the UE to operate in the S-TRP mode comprise computer-executable instructions that, when executed by the UE, cause the UE to: receive one or more physical download control channels (PDCCHs) carrying downlink control information (DCI) from a single TRP; and receive one or more physical download shared channels (PDSCHs) from the single TRP.

Clause 66. The non-transitory computer-readable medium of any of clauses 64 to 65, wherein the computer-executable instructions that, when executed by the UE, cause the UE to operate in the multi-TRP mode comprise computer-executable instructions that, when executed by the UE, cause the UE to: receive a PDCCH carrying DCI from a single TRP; and receive multiple PDSCHs from multiple TRPs.

Clause 67. The non-transitory computer-readable medium of any of clauses 64 to 65, wherein the computer-executable instructions that, when executed by the UE, cause the UE to operate in the multi-TRP mode comprise computer-executable instructions that, when executed by the UE, cause the UE to: receive multiple PDCCHs from multiple TRPs, wherein each of the multiple PDCCHs carry respective DCIs; and receive multiple physical download shared channels (PDSCHs) from the multiple TRPs.

Clause 68. The non-transitory computer-readable medium of any of clauses 64 to 67, wherein: the network entity is a location server, and the measurement request is received from the location server in one or more Long-Term Evolution (LTE) positioning protocol (LPP) messages.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair. DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless communication performed by a user equipment (UE), comprising:
operating in a multi-transmission-reception point (multi-TRP) mode;
engaging in a positioning session with a network entity while operating in the multi-TRP mode; and
reporting a set of positioning capabilities for the positioning session to the network entity, wherein the set of positioning capabilities indicate one or more enhanced positioning capabilities of the UE to perform positioning operations based on the UE operating in the multi-TRP mode, and wherein the one or more enhanced positioning capabilities are greater than one or more corresponding positioning capabilities of the UE to perform positioning operations based on the UE operating in a single-transmission-reception point (S-TRP) mode.

2. The method of claim 1, further comprising:
deactivating the multi-TRP mode during the positioning session; and
maintaining the one or more enhanced positioning capabilities for a remainder of the positioning session.

3. The method of claim 1, further comprising:
reducing one or more capabilities of the multi-TRP mode during the positioning session; and
maintaining the one or more enhanced positioning capabilities for a remainder of the positioning session.

4. The method of claim 1, wherein:
the one or more enhanced positioning capabilities include one or more enhanced positioning reference signal (PRS) processing capabilities, and
the one or more enhanced PRS processing capabilities are greater than PRS processing capabilities of the UE in the S-TRP mode.

5. The method of claim 1, wherein:
the UE comprises multiple antenna panels,
the one or more enhanced positioning capabilities include at least one enhanced positioning capability based on timing error groups (TEGs) supported by the multiple antenna panels, and
the at least one enhanced positioning capability is based on TEGs supported by the multiple antenna panels being greater than positioning capabilities of TEGs supported by the multiple antenna panels in the S-TRP mode.

6. The method of claim 1, wherein:
the UE comprises multiple antenna panels, and
the one or more enhanced positioning capabilities includes at least one enhanced capability for measuring a first PRS resource based on different TEGs, and
the at least one enhanced capability of measuring the first PRS resource based on the different TEGs is greater than a capability of measuring the first PRS resource based on the different TEGs in the S-TRP mode.

7. The method of claim 1, wherein:
the UE comprises multiple antenna panels,
the one or more enhanced positioning capabilities includes at least one enhanced capability for measuring different PRS resources from TEGs having a first timing error margin, and
the first error timing margin is less than a second timing error margin associated with measuring the different PRS resources from the TEGs in the S-TRP mode.

8. The method of claim 1, wherein engaging in the positioning session with the network entity comprises:
receiving assistance data from the network entity, wherein the assistance data indicates one or more PRS resources to be measured for the positioning session; and
reporting, to the network entity, one or more measurements of the one or more PRS resources indicated in the assistance data.

9. The method of claim 1, wherein operating in the S-TRP mode comprises:
receiving one or more physical download control channels (PDCCHs) carrying downlink control information (DCI) from a single TRP; and
receiving one or more physical download shared channels (PDSCHs) from the single TRP.

10. The method of claim 1, wherein operating in the multi-TRP mode comprises:
receiving a PDCCH carrying DCI from a single TRP; and
receiving multiple PDSCHs from multiple TRPs.

11. The method of claim 1, wherein operating in the multi-TRP mode comprises:
receiving multiple PDCCHs from multiple TRPs, wherein each of the multiple PDCCHs carry respective DCIs; and
receiving multiple physical download shared channels (PDSCHs) from the multiple TRPs.

12. The method of claim 1, wherein:
the network entity is a location server, and
the set of positioning capabilities for the positioning session are reported to the location server in one or more Long-Term Evolution (LTE) positioning protocol (LPP) messages.

13. A method of wireless communication performed by a user equipment (UE), comprising:
engaging in a positioning session with a network entity while operating in a multi-transmission-reception point (multi-TRP) mode;
receiving a measurement request to measure a plurality of positioning reference signal (PRS) resources for the positioning session; and
measuring an enhanced set of the plurality of PRS resources during a measurement period based on the UE being in the multi-TRP mode, wherein the enhanced set of the plurality of PRS resources includes more PRS resources than a nominal set of the plurality of PRS resources that the UE is capable of measuring during the measurement period, measurement occasion, or measurement instance while operating in a single-transmission-reception point (S-TRP) mode.

14. The method of claim 13, wherein operating in the S-TRP mode comprises:
receiving one or more physical download control channels (PDCCHs) carrying downlink control information (DCI) from a single TRP; and
receiving one or more physical download shared channels (PDSCHs) from the single TRP.

15. The method of claim 13, wherein operating in the multi-TRP mode comprises:
receiving a PDCCH carrying DCI from a single TRP; and
receiving multiple PDSCHs from multiple TRPs.

16. The method of claim 13, wherein operating in the multi-TRP mode comprises:
receiving multiple PDCCHs from multiple TRPs, wherein each of the multiple PDCCHs carry respective DCIs; and
receiving multiple physical download shared channels (PDSCHs) from the multiple TRPs.

17. The method of claim 13, wherein:
the network entity is a location server, and
the measurement request is received from the location server in one or more Long-Term Evolution (LTE) positioning protocol (LPP) messages.

18. A user equipment (UE), comprising:
a memory;
at least one transceiver; and
at least one processor communicatively coupled to the memory and the at least one transceiver, the at least one processor configured to:
operate in a multi-transmission-reception point (multi-TRP) mode;
engage in a positioning session with a network entity while operating in the multi-TRP mode; and
report, via the at least one transceiver, a set of positioning capabilities for the positioning session to the network entity, wherein the set of positioning capabilities indicate one or more enhanced positioning capabilities of the UE to perform positioning operations based on the UE operating in the multi-TRP mode, and wherein the one or more enhanced positioning capabilities are greater than one or more corresponding positioning capabilities of the UE to perform positioning operations based on the UE operating in a single-transmission-reception point (S-TRP) mode.

19. The UE of claim 18, wherein the at least one processor is further configured to:
deactivate the multi-TRP mode during the positioning session; and
maintain the one or more enhanced positioning capabilities for a remainder of the positioning session.

20. The UE of claim 18, wherein the at least one processor is further configured to:
reduce one or more capabilities of the multi-TRP mode during the positioning session; and
maintain the one or more enhanced positioning capabilities for a remainder of the positioning session.

21. The UE of claim 18, wherein:
the one or more enhanced positioning capabilities include one or more enhanced positioning reference signal (PRS) processing capabilities, and
the one or more enhanced PRS processing capabilities are greater than PRS processing capabilities of the UE in the S-TRP mode.

22. The UE of claim 18, wherein:
the UE comprises multiple antenna panels,
the one or more enhanced positioning capabilities include at least one enhanced positioning capability based on timing error groups (TEGs) supported by the multiple antenna panels, and
the at least one enhanced positioning capability is based on TEGs supported by the multiple antenna panels being greater than positioning capabilities of TEGs supported by the multiple antenna panels in the S-TRP mode.

23. The UE of claim 18, wherein:
the UE comprises multiple antenna panels, and
the one or more enhanced positioning capabilities includes at least one enhanced capability for measuring a first PRS resource based on different TEGs, and
the at least one enhanced capability of measuring the first PRS resource based on the different TEGs is greater than a capability of measuring the first PRS resource based on the different TEGs in the S-TRP mode.

24. The UE of claim 18, wherein:
the UE comprises multiple antenna panels,
the one or more enhanced positioning capabilities includes at least one enhanced capability for measuring different PRS resources from TEGs having a first timing error margin, and
the first error timing margin is less than a second timing error margin associated with measuring the different PRS resources from the TEGs in the S-TRP mode.

25. The UE of claim 18, wherein the at least one processor configured to engage in the positioning session with the network entity comprises the at least one processor configured to:
receive, via the at least one transceiver, assistance data from the network entity, wherein the assistance data indicates one or more PRS resources to be measured for the positioning session; and
report, via the at least one transceiver, to the network entity, one or more measurements of the one or more PRS resources indicated in the assistance data.

26. The UE of claim 18, wherein the at least one processor configured to operate in the S-TRP mode comprises the at least one processor configured to:
receive, via the at least one transceiver, one or more physical download control channels (PDCCHs) carrying downlink control information (DCI) from a single TRP; and
receive, via the at least one transceiver, one or more physical download shared channels (PDSCHs) from the single TRP.

27. The UE of claim 18, wherein the at least one processor configured to operate in the multi-TRP mode comprises the at least one processor configured to:
receive, via the at least one transceiver, a PDCCH carrying DCI from a single TRP; and
receive, via the at least one transceiver, multiple PDSCHs from multiple TRPs.

28. The UE of claim 18, wherein the at least one processor configured to operate in the multi-TRP mode comprises the at least one processor configured to:
receive, via the at least one transceiver, multiple PDCCHs from multiple TRPs, wherein each of the multiple PDCCHs carry respective DCIs; and
receive, via the at least one transceiver, multiple physical download shared channels (PDSCHs) from the multiple TRPs.

29. The UE of claim 18, wherein:
the network entity is a location server, and
the set of positioning capabilities for the positioning session are reported to the location server in one or more Long-Term Evolution (LTE) positioning protocol (LPP) messages.

30. A user equipment (UE), comprising:
a memory;
at least one transceiver; and
at least one processor communicatively coupled to the memory and the at least one transceiver, the at least one processor configured to:
engage in a positioning session with a network entity while operating in a multi-transmission-reception point (multi-TRP) mode;
receive, via the at least one transceiver, a measurement request to measure a plurality of positioning reference signal (PRS) resources for the positioning session; and
measure an enhanced set of the plurality of PRS resources during a measurement period based on the UE being in the multi-TRP mode, wherein the enhanced set of the plurality of PRS resources includes more PRS resources than a nominal set of the plurality of PRS resources that the UE is capable of measuring during the measurement period, measurement occasion, or measurement instance while operating in a single-transmission-reception point (S-TRP) mode.
